(19) United States
(12) Patent Application Publication
(10) Pub. No.: US 2026/0211346 A1
(43) Pub. Date: Jul. 23, 2026

(54) ELECTROPHOTOGRAPHIC PHOTORECEPTOR, PROCESS CARTRIDGE, AND IMAGE FORMING APPARATUS

(71) Applicant: KYOCERA DOCUMENT SOLUTIONS INC., OSAKA, (JP)

(72) Inventors: RYOHEI YAMASAKI, OSAKA (JP); TETSUYA SENDA, OSAKA (JP); ZUISHIN JO, OSAKA (JP)

(21) Appl. No.: 19/452,412

(22) Filed: Jan. 19, 2026

(30) Foreign Application Priority Data
Jan. 21, 2025 (JP) 2025-008664

(51) Int. Cl. G03G 5/047; G03G 5/05; G03G 5/06; G03G 15/04; G03G 15/16; G03G 21/18

(52) U.S. Cl. CPC G03G 5/047; G03G 5/0567; G03G 5/06142; G03G 5/0696; G03G 15/04; G03G 15/16; G03G 21/18

(57) ABSTRACT

An electrophotographic photoreceptor includes a conductive base, and a photosensitive layer. The photosensitive layer includes a charge generating layer and a charge transporting layer. The charge transporting layer includes a hole transporting agent, a binder resin, and a phthalocyanine pigment. The binder resin includes a polyarylate resin. The polyarylate resin includes a repeating unit represented by a general formula (1), a repeating unit represented by a chemical formula (2), and a repeating unit represented by a chemical formula (3). A ratio n₁/n₂ of the number n₁ of the repeating unit represented by the general formula (1) to the number n₂ of the repeating unit represented by the chemical formula (2) is 1.0 or more. The hole transporting agent includes a compound represented by a general formula (10).

### CROSS-REFERENCE TO RELATED PATENT APPLICATION

This application claims the benefit of Japanese Priority Patent Application JP 2025-008664 filed on Jan. 21, 2025, the entire contents of which are incorporated herein by reference.

### FIELD OF THE DISCLOSURE

The present disclosure relates to an electrophotographic photoreceptor, a process cartridge, and an image forming apparatus.

### BACKGROUND OF THE DISCLOSURE

Electrophotographic photoreceptors are used as image carriers in electrophotographic image forming apparatuses (e.g., printers or multifunction devices). The electrophotographic photoreceptors are roughly classified into a single-layer electrophotographic photoreceptor and a stacked electrophotographic photoreceptor on the basis of the structure of their photosensitive layer. The former includes a photosensitive layer has a charge generating function and a charge transporting function in a single layer, and the latter includes a photosensitive layer in which these functions are separated into a charge generating layer and a charge transporting layer, these layers being stacked. In particular, the stacked electrophotographic photoreceptor is effective due to the wide range of material selection according to the function.

In recent years, in such image forming apparatuses, developments have been made to increase the speed and extend the lifetime of the machine. In order to extend the lifetime of the stacked electrophotographic photoreceptor, a polyarylate resin has been used as a binder resin included in the charge transporting layer to impart wear resistance, which allows to withstand repeated use in processes. However, in known photoreceptors using a polyarylate resin, charges tend to accumulate in the charge transporting layer. This easily causes image defects such as fogging where the toner adheres to a non-image portion and an image memory (afterimage) where the history of the previous image is retained, in the formed image.

For this reason, an electrophotographic photoreceptor that is capable of achieving both improvement in wear resistance and suppression of image defects caused by fogging and an image memory in the formed image is desired.

### SUMMARY OF THE DISCLOSURE

An electrophotographic photoreceptor according to an embodiment of the present disclosure includes; a conductive base; and a photosensitive layer. The photosensitive layer includes a charge generating layer and a charge transporting layer. The charge transporting layer includes a hole transporting agent, a binder resin, and a phthalocyanine pigment. The binder resin includes a polyarylate resin. The polyarylate resin includes a repeating unit represented by the following general formula (1), a repeating unit represented by the following chemical formula (2), and a repeating unit represented by the following chemical formula (3). A ratio n₁/n₂ of the number n₁ of repeating units represented by the general formula (1) to the number n₂ of repeating unit represented by the chemical formula (2) is 1.0 or more. The hole transporting agent includes a compound represented by the following general formula (10).

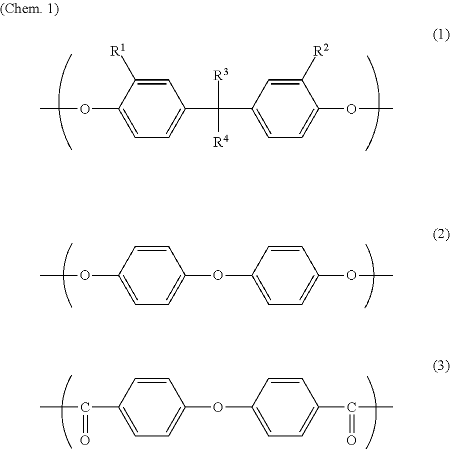

In the general formula (1),
R¹ and R² each independently represent a hydrogen atom or a methyl group, R³ represents a methyl group, and R⁴ represents a hydrogen atom or an alkyl group having 2 or 3 carbon atoms, or
R¹ and R² each independently represent a methyl group, and R³ and R⁴ are bonded to each other to represent a cycloalkylidene group having 5 or 6 carbon atoms.

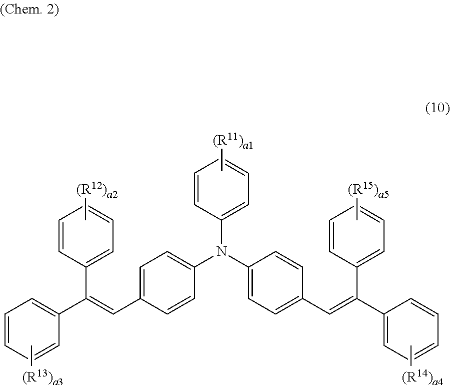

In the general formula (10),
R¹¹ to R¹⁵ each independently represent an alkyl group having 1 to 8 carbon atoms or an alkoxy group having 1 to 8 carbon atoms, and a1, a2, a3, a4, and a5 each independently represent an integer of 0 or more and 5 or less.

### BRIEF DESCRIPTION OF THE DRAWINGS

FIG. 1 is a partial cross-sectional view of an electrophotographic photoreceptor according to a first embodiment of the present disclosure.

FIG. 2 is a partial cross-sectional view of an electrophotographic photoreceptor according to the first embodiment of the present disclosure.

FIG. 3 is a partial cross-sectional view of the electrophotographic photoreceptor according to the first embodiment of the present disclosure.

FIG. 4 is a diagram showing an example of a configuration of an image forming apparatus according to a second embodiment of the present disclosure.

FIG. 5 is a diagram showing an example of a configuration of a development device shown in FIG. 4.

### DETAILED DESCRIPTION OF THE EXEMPLARY EMBODIMENTS

Embodiments of the present disclosure will be described below in detail. However, the present disclosure is not limited to the embodiments described below. The present disclosure may be implemented with appropriate modifications within the scope of the present disclosure. Note that the descriptions may be omitted where they are redundant, but the essence of the present disclosure is not limited. Hereinafter, the term “-based” is added after the compound name to collectively refer to the compound and derivatives thereof in some cases. Further, in the case of adding the term “-based” after a compound to refer to a polymer name, it means that the repeating unit of the polymer is derived from the compound or a derivative thereof.

First, substituent groups used in the present specification will be described. Examples of the halogen atom (halogen group) include a fluorine atom (fluoro group), a chlorine atom (chloro group), a bromine atom (bromo group), and an iodine atom (iodo group).

An alkyl group having 1 to 8 carbon atoms, an alkyl group having 1 or more and 6 or less carbon atoms, and an alkyl group having 1 or more and 3 or less carbon atoms are each linear or branched-chain and unsubstituted, unless otherwise specified. Examples of the alkyl group having 1 to 8 carbon atoms include a methyl group, an ethyl group, an n-propyl group, an isopropyl group, an n-butyl group, a sec-butyl group, a tert-butyl group, an n-pentyl group, a 1-methylbutyl group, a 2-methylbutyl group, a 3-methylbutyl group, a 1-ethylpropyl group, a 2-ethylpropyl group, a 1,1-dimethylpropyl group, a 1,2-dimethylpropyl group, a 2,2-dimethylpropyl group, a 1,2-dimethylpropyl group, an n-hexyl group, a 1-methylpentyl group, a 2-methylpentyl group, a 3-methylpentyl group, a 4-methylpentyl group, a 1,1-dimethylbutyl group, a 1,2-dimethylbutyl group, a 1,3-dimethylbutyl group, a 2,2-dimethylbutyl group, a 2,3-dimethylbutyl group, a 3,3-dimethylbutyl group, a 1,1,2-trimethylpropyl group, a 1,2,2-trimethylpropyl group, a 1-aethylbutyl group, a 2-ethylbutyl group, a 3-ethylbutyl group, linear and branched-chain heptyl groups, and linear and branched-chain octyl groups. Examples of the alkyl group having 1 or more and 6 or less carbon atoms and the alkyl group having 1 or more and 3 or less carbon atoms include groups having the corresponding number of carbon atoms, of the groups mentioned as the examples of the alkyl group having 1 to 8 carbon atoms.

The alkoxy group having 1 to 8 carbon atoms and the alkoxy group having 1 or more and 6 or less carbon atoms are linear or branched-chain and unsubstituted, unless otherwise specified. Examples of the alkoxy group having 1 to 8 carbon atoms include a methoxy group, an ethoxy group, an n-propoxy group, an isopropoxy group, an n-butoxy group, a sec-butoxy group, a tert-butoxy group, an n-pentoxy group, a 1-methylbutoxy group, a 2-methylbutoxy group, a 3-methylbutoxy group, a 1-ethylpropoxy group, a 2-ethylpropoxy group, a 1,1-dimethylpropoxy group, a 1,2-dimethylpropoxy group, a 2,2-dimethylpropoxy group, a 1,2-dimethylpropoxy group, an n-hexyloxy group, a 1-methylpentyloxy group, a 2-methylpentyloxy group, a 3-methylpentyloxy group, a 4-methylpentyloxy group, a 1,1-dimethylbutoxy group, a 1,2-dimethylbutoxy group, a 1,3-dimethylbutoxy group, a 2,2-dimethylbutoxy group, a 2,3-dimethylbutoxy group, a 3,3-dimethylbutoxy group, a 1,1,2-trimethylpropoxy group, a 1,2,2-trimethylpropoxy group, a 1-ethylbutoxy group, a 2-ethylbutoxy group, a 3-ethylbutoxy group, linear and branched-chain heptyloxy groups, and linear and branched-chain octyloxy groups. Examples of the alkoxy group having 1 or more and 6 or less carbon atoms include groups having 1 or more and 6 or less carbon atoms, of the groups mentioned as the examples of the alkoxy group having 1 to 8 carbon atoms.

An aryloxy group having 6 or more and 14 or less carbon atoms is unsubstituted, unless otherwise specified. Examples of the aryloxy group having 6 or more and 14 or less carbon atoms include a phenoxy group, a naphthoxy group, an indacenyloxy group, a biphenylenyloxy group, an acenaphthylenyloxy group, an anthryloxy group, and a phenanthryloxy group. The substituent group used in the present specification has been described above.

### First Embodiment: Electrophotographic Photoreceptor

According to the embodiment of the present disclosure, it is possible to provide an electrophotographic photoreceptor, a process cartridge, and an image forming apparatus that are capable of achieving both improvement in wear resistance and suppression of image defects caused by fogging and an image memory.

In the conventional photoreceptor, it has not been possible to sufficiently suppress the occurrence of image defects caused by fogging and an image memory. On the other hand, in the electrophotographic photoreceptor according to the embodiment of the present disclosure, by including a specific polyarylate resin as a binder resin included in the charge transporting layer, it is possible to improve wear resistance. Further, by including a specific phthalocyanine pigment, it is possible to effectively cancel out the charges accumulated in the charge transporting layer and suppress the occurrence of an image memory. Further, by including a specific hole transporting agent, it is possible to make charging characteristics of the toner favorable and suppress the occurrence of fogging. In such an electrophotographic photoreceptor according to the embodiment of the present disclosure, the synergistic effect of the above components allows the wear resistance of the photoreceptor to be improved and the occurrence of image defects caused by fogging and an image memory to be suppressed more effectively.

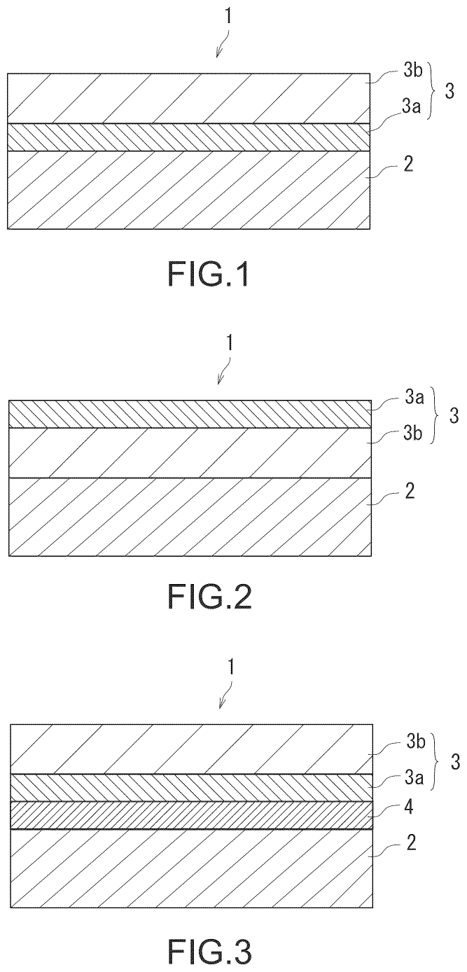

A structure of an electrophotographic photoreceptor 1 according to this embodiment (hereinafter, referred to as a photoreceptor 1 in some cases) will be described below with reference to FIG. 1 to FIG. 3. FIG. 1 to FIG. 3 each show a partial cross section of the photoreceptor 1.

### [Overall Configuration]

As shown in FIG. 1, the photoreceptor 1 includes, for example, a conductive base 2 and a photosensitive layer 3. The photosensitive layer 3 includes a charge generating layer 3a and a charge transporting layer 3b. That is, the photoreceptor 1 is a stacked electrophotographic photoreceptor that includes, as the photosensitive layer 3, the charge generating layer 3a and the charge transporting layer 3b. The charge generating layer 3a is, for example, a single layer. The charge transporting layer 3b is, for example, a single layer.

As shown in FIG. 1, in the photoreceptor 1, the charge generating layer 3a may be provided on the conductive base 2 and the charge transporting layer 3b may be provided on the charge generating layer 3a. Alternatively, as shown in FIG. 2, in the photoreceptor 1, the charge transporting layer 3b may be provided on the conductive base 2 and the charge generating layer 3a may be provided on the charge transporting layer 3b.

As shown in FIG. 3, the photoreceptor 1 may include the conductive base 2, the photosensitive layer 3, and an intermediate layer 4 (undercoat layer). The intermediate layer 4 is provided between the conductive base 2 and the photosensitive layer 3. As shown in FIG. 1 and FIG. 2, in the photoreceptor 1, the photosensitive layer 3 may be provided directly on the conductive base 2. Alternatively, as shown in FIG. 3, in the photoreceptor 1, the photosensitive layer 3 may be provided on the conductive base 2 via the intermediate layer 4. In the case where the photoreceptor 1 includes the intermediate layer 4, as shown in FIG. 3, the intermediate layer 4 may be provided on the conductive base 2, the charge generating layer 3a may be provided on the intermediate layer 4, and the charge transporting layer 3b may be provided on the charge generating layer 3a. Alternatively, the intermediate layer 4 may be provided on the conductive base 2, the charge transporting layer 3b may be provided on the intermediate layer 4, and the charge generating layer 3a may be provided on the charge transporting layer 3b.

The photoreceptor 1 may include the conductive base 2, the photosensitive layer 3, and a protective layer (not shown). The protective layer is provided on the photosensitive layer 3. As shown in FIG. 1 and FIG. 2, the photosensitive layer 3 (e.g., the charge transporting layer 3b or the charge generating layer 3a) may be provided as the top surface layer of the photoreceptor 1. Alternatively, the protective layer may be provided as the top surface layer of the photoreceptor 1.

It is favorable that the charge transporting layer 3b is included as the top surface layer of the photoreceptor 1 as shown in FIG. 1. It is more favorable that the charge transporting layer 3b is a single layer and included as the top surface layer of the photoreceptor 1 from the viewpoint that the effects of the present disclosure described below become more significant.

The charge transporting layer 3b is characterized by including a binder resin including a predetermined polyarylate resin, a predetermined hole transporting agent, and a predetermined phthalocyanine pigment. This allows the occurrence of fogging and an image memory in the formed image to be suppressed while improving the wear resistance of the photoreceptor 1.

In detail, by including a predetermined polyarylate resin, it is possible to improve wear resistance. In this regard, depending on other components included in the charge transporting layer 3b, the solubility of the polyarylate resin deteriorates, making it difficult to favorably form the photosensitive layer 3 (thin film) and causing wear resistance to deteriorate in some cases. On the other hand, in the electrophotographic photoreceptor according to the embodiment of the present disclosure, the predetermined hole transporting agent and the predetermined phthalocyanine pigment included together with the polyarylate resin allow the photosensitive layer 3 to be formed favorably without significantly affecting the solubility of the polyarylate resin, thereby improving the wear resistance.

When the charge transporting layer 3b includes the predetermined phthalocyanine pigment, charges tend to be generated from not only the charge generating layer 3a but also the predetermined phthalocyanine pigment included in the charge transporting layer 3b during exposure of the photoreceptor 1. This achieves the effect of cancelling out the charges accumulated in the charge transporting layer 3b, thereby suppressing the occurrence of an image memory. This advantage becomes more significant in the case where the predetermined polyarylate resin and the predetermined hole transporting agent are included in the charge transporting layer 3b.

Further, when the charge transporting layer 3b includes the predetermined hole transporting agent, the chargeability of the toner becomes favorable and it is possible to suppress the occurrence of fogging in the formed image. This advantage becomes more significant in the case where the predetermined polyarylate resin (PA) and the predetermined phthalocyanine pigment are included in the charge transporting layer 3b. Note that the reason why the occurrence of fogging is suppressed will be described using an image forming apparatus 100 described below.

Further, when the charge transporting layer 3b includes the predetermined hole transporting agent, the electrical characteristics of the photoreceptor 1 tend to be favorable. In particular, sensitivity characteristics when printing a solid image and sensitivity characteristics when printing a halftone image become favorable, and favorable image quality is easily achieved. This advantage also becomes more significant in the case where the predetermined polyarylate resin and the predetermined phthalocyanine pigment are included in the charge transporting layer 3b.

As described above, according to the photoreceptor 1 according to the embodiment of the present disclosure, which includes the charge transporting layer 3b including the predetermined polyarylate resin, the predetermined hole transporting agent, and the predetermined phthalocyanine pigment, the improvement in wear resistance of the photoreceptor 1 allows the image forming apparatus 100 that has a longer lifetime and is capable of producing a high-quality image with fewer image defects to be realized.

The photoreceptor 1 will be described below in more detail.

### [Charge Transporting Layer]

The charge transporting layer 3b includes a binder resin, a hole transporting agent, and a phthalocyanine pigment, as described above. The charge transporting layer 3b may include an additive as necessary, in addition to the binder resin, the hole transporting agent, and the phthalocyanine pigment. The thickness of the charge transporting layer 3b is not particularly limited, but is favorably 2 μm or more and 100 μm or less, more favorably 5 μm or more and 50 μm or less. The charge transporting layer 3b is, for example, a single layer.

### (Binder Resin)

The charge transporting layer 3b includes a polyarylate resin as a binder resin. The polyarylate resin includes a repeating unit represented by the general formula (1), a repeating unit represented by the chemical formula (2), and a repeating unit represented by the chemical formula (3). The ratio n₁/n₂ of the number n₁ of the repeating unit represented by the general formula (1) to the number n₂ of the repeating unit represented by the chemical formula (2) is 1.0 or more.

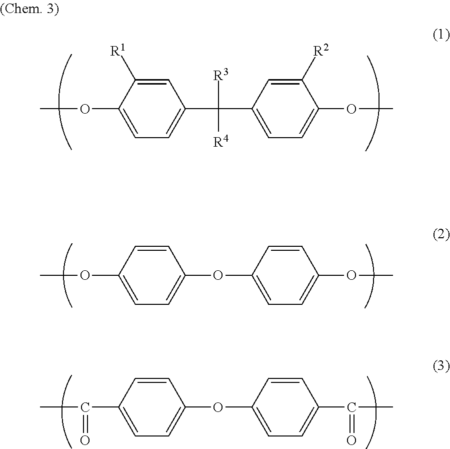

In the general formula (1), R¹ and R² each independently represent a hydrogen atom or a methyl group, R³ represents a methyl group, and R⁴ represents a hydrogen atom or an alkyl group having 2 or 3 carbon atoms. Alternatively, R¹ and R² each independently represent a methyl group, and R³ and R⁴ are bonded to each other to represent a cycloalkylidene group having 5 or 6 carbon atoms.

Hereinafter, the repeating unit represented by the general formula (1), the repeating unit represented by the chemical formula (2), and the repeating unit represented by the chemical formula (3) will respectively be referred to as a repeating unit (1), a repeating unit (2), and a repeating unit (3) in some cases. Further, a polyarylate resin that includes the repeating unit (1), the repeating unit (2), and the repeating unit (3), in which the ratio n₁/n₂ of the number n₁ of the repeating unit (1) to the number n₂ of the repeating unit (2) is 1.0 or more, will be referred to as a polyarylate resin (PA) in some cases.

The polyarylate resin (PA) allows the wear resistance of the photoreceptor 1 to be improved when included in the charge transporting layer 3b. The reasons for this is presumed as follows.

First, the polyarylate resin (PA) includes the repeating unit (2) and the repeating unit (3). This allows the wear resistance of the photoreceptor 1 to be improved.

Second, the polyarylate resin (PA) includes the repeating unit (1). This allows the solubility of the polyarylate resin (PA) in a solvent for forming a charge transporting layer to be improved. Further, when the ratio n₁/n₂ of the number n₁ of the repeating unit (1) to the number n₂ of the repeating unit (2) is 1.0 or more, the solubility of the polyarylate resin (PA) in the solvent for forming a charge transporting layer can be further improved. The improvement in solubility of the polyarylate resin (PA) allows the charge transporting layer 3b to be formed suitably and the wear resistance of the photoreceptor 1 to be improved.

Next, the general formula (1) will be described in detail. Examples of the alkyl group having 2 or 3 carbon atoms represented by R⁴ in the general formula (1) include an ethyl group, an n-propyl group, and an isopropyl group. As the alkyl group having 2 or 3 carbon atoms, an ethyl group or an isopropyl group is favorable.

Examples of the cycloalkylidene group having 5 or 6 carbon atoms represented by R³ and R⁴ in the general formula (1) bonded to each other include a cyclopentylidene group and a cyclohexylidene group. The cyclopentylidene group and the cyclohexylidene group are respectively divalent groups represented by the following chemical formulae (5) and (6). As the cycloalkylidene group having 5 or 6 carbon atoms, a cyclohexylidene group is favorable.

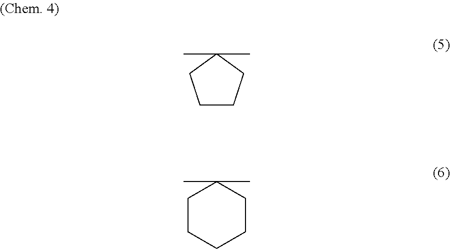

Suitable examples of the repeating unit (1) include repeating units represented by a chemical formula (1-1), a chemical formula (1-2), a chemical formula (1-3), a chemical formula (1-4), and a chemical formula (1-5). Hereinafter, the repeating unit represented by the chemical formula (1-1), the chemical formula (1-2), the chemical formula (1-3), the chemical formula (1-4), and the chemical formula (1-5) will respectively be referred to as repeating units (1-1), (1-2), (1-3), (1-4), and (1-5) in some cases.

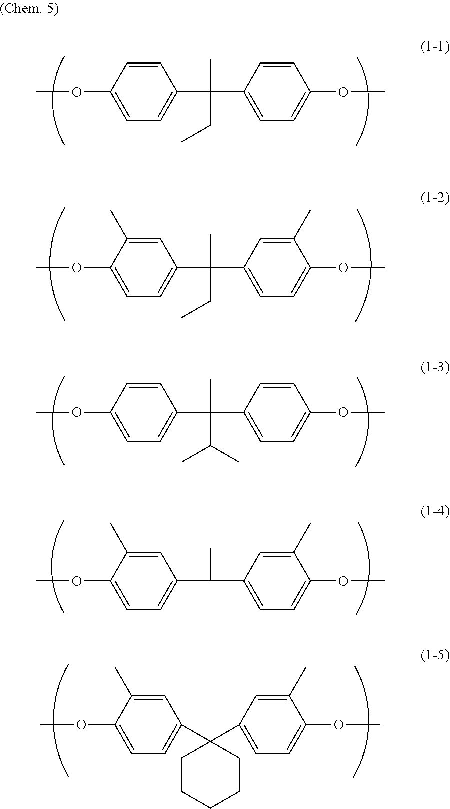

The polyarylate resin (PA) may include only one type of repeating unit (1). Alternatively, the polyarylate resin (PA) may include two or more types of repeating units (1).

The ratio n₁/n₂ of the number n₁ of the repeating unit (1) included in the polyarylate resin (PA) to the number n₂ of the repeating unit (2) included in the polyarylate resin (PA) is 1.0 or more. That is, the number n₁ of the repeating unit (1) is equal to or larger than the number n₂ of the repeating unit (2). When the ratio n₁/n₂ is 1.0 or more, it is possible to improve the solubility of the polyarylate resin (PA) in the solvent for forming a charge transporting layer and improve he wear resistance of the photoreceptor 1. In order to improve the wear resistance of the photoreceptor 1, the ratio n₁/n₂ is favorably 10.0 or less, more favorably 5.0 or less. In order to improve the solubility of the polyarylate resin (PA) in the solvent for forming a charge transporting layer and improve the wear resistance of the photoreceptor 1, the ratio n₁/n₂ is also favorably within the range of two values selected from the group consisting of 1.0, 2.0, 3.0, 5.0, and 10.0. The ratio n₁/n₂ may be, for example, 1.0 or more and less than 2.0, or 2.0 or more and 5.0 or less. The ratio n₁/n₂ may be, for example, 1.0 or 3.0.

The ratio n₁/n₂ can be adjusted by changing the amount of a compound (BP-1) and the amount of a compound (BP-2) to be added when producing the polyarylate resin (PA). Note that the compound (BP-1) and the compound (BP-2) will be described below.

The ratio n₁/n₂ can be obtained by measuring the 1H-NMR spectrum of the polyarylate resin (PA) using a proton nuclear magnetic resonance spectrometer and calculating the ratio of the peaks characteristic of each repeating unit in the obtained 1H-NMR spectrum.

Specific examples of the polyarylate resin (PA) include the following polyarylate resins.

A polyarylate resin including the repeating units (1-1), (2), and (3), in which the ratio n₁/n₂ is 2.0 or more and 5.0 or less (hereinafter, referred to as a polyarylate resin (I) in some cases);
a polyarylate resin including the repeating units (1-2), (2), and (3), in which the ratio n₁/n₂ is 2.0 or more and 5.0 or less (hereinafter, referred to as a polyarylate resin (II) in some cases);
a polyarylate resin including the repeating units (1-3), (2), and (3), in which the ratio n₁/n₂ is 2.0 or more and 5.0 or less (hereinafter, referred to as a polyarylate resin (III) in some cases);
a polyarylate resin including the repeating units (1-4), (2), and (3), in which the ratio n₁/n₂ is 2.0 or more and 5.0 or less (hereinafter, referred to as a polyarylate resin (IV) in some cases);
a polyarylate resin including the repeating units (1-5), (2), and (3), in which the ratio n₁/n₂ is 2.0 or more and 5.0 or less (hereinafter, referred to as a polyarylate resin (V) in some cases); and
a polyarylate resin including the repeating units (1-1), (2), and (3), in which the ratio n₁/n₂ is 1.0 or more and less than 2.0 (hereinafter, referred to as a polyarylate resin (VI) in some cases).

More specific examples of the polyarylate resin (PA) include polyarylate resins represented by chemical formulae (R-1) to (R-6) (hereinafter, respectively referred to as polyarylate resins (R-1) to (R-6) in some cases). Note that in the chemical formulae (R-1) to (R-6), the number at the bottom right of each repeating unit indicates the percentage (%) of the number of repeating units to the total number of repeating units included in the polyarylate resin. The total number of repeating units is the sum of the number of repeating units derived from bisphenol and the number of repeating units derived from dicarboxylic acid. Further, for convenience of description, each of the chemical formulae (R-1) to (R-6) includes two or more repeating units (3). However, the percentage of the number of repeating units (3) to the total number of repeating units included in each of the polyarylate resins (R-1) to (R-6) is 50.0% (the sum of the numbers at the bottom right of the two repeating units (3)).

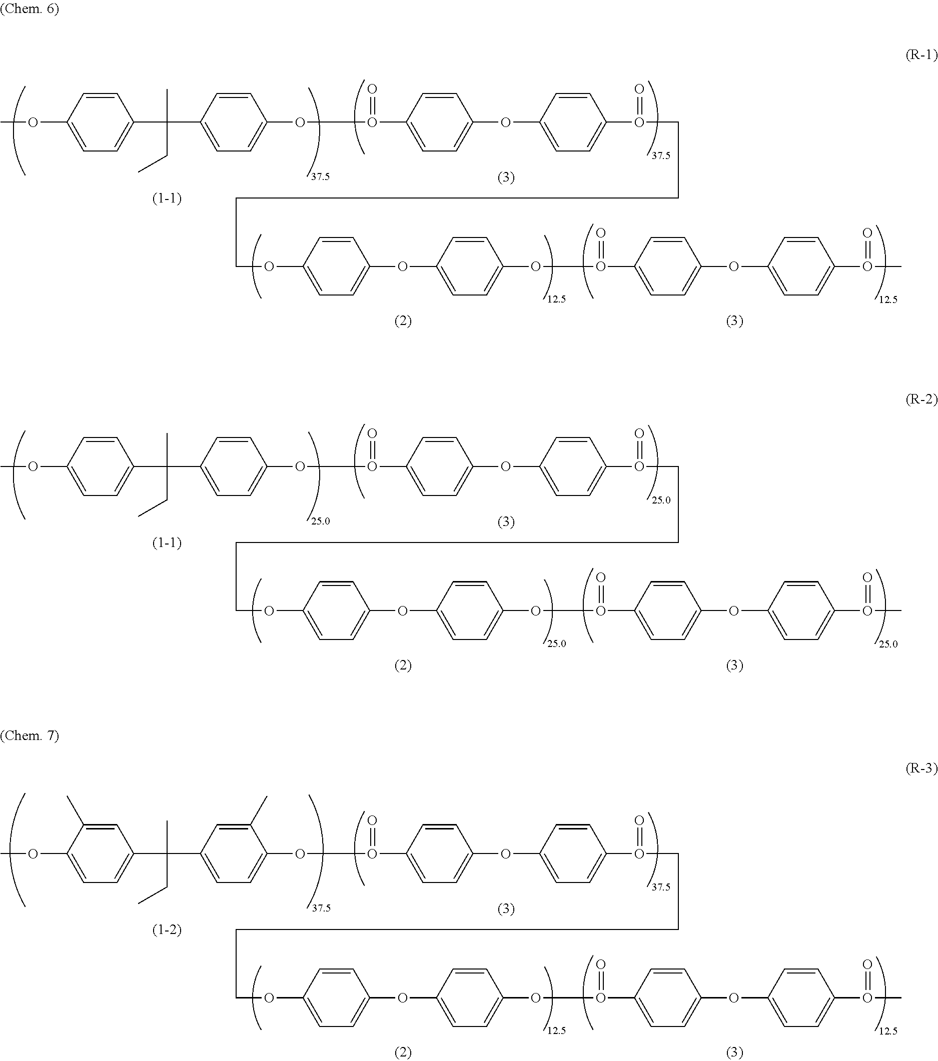

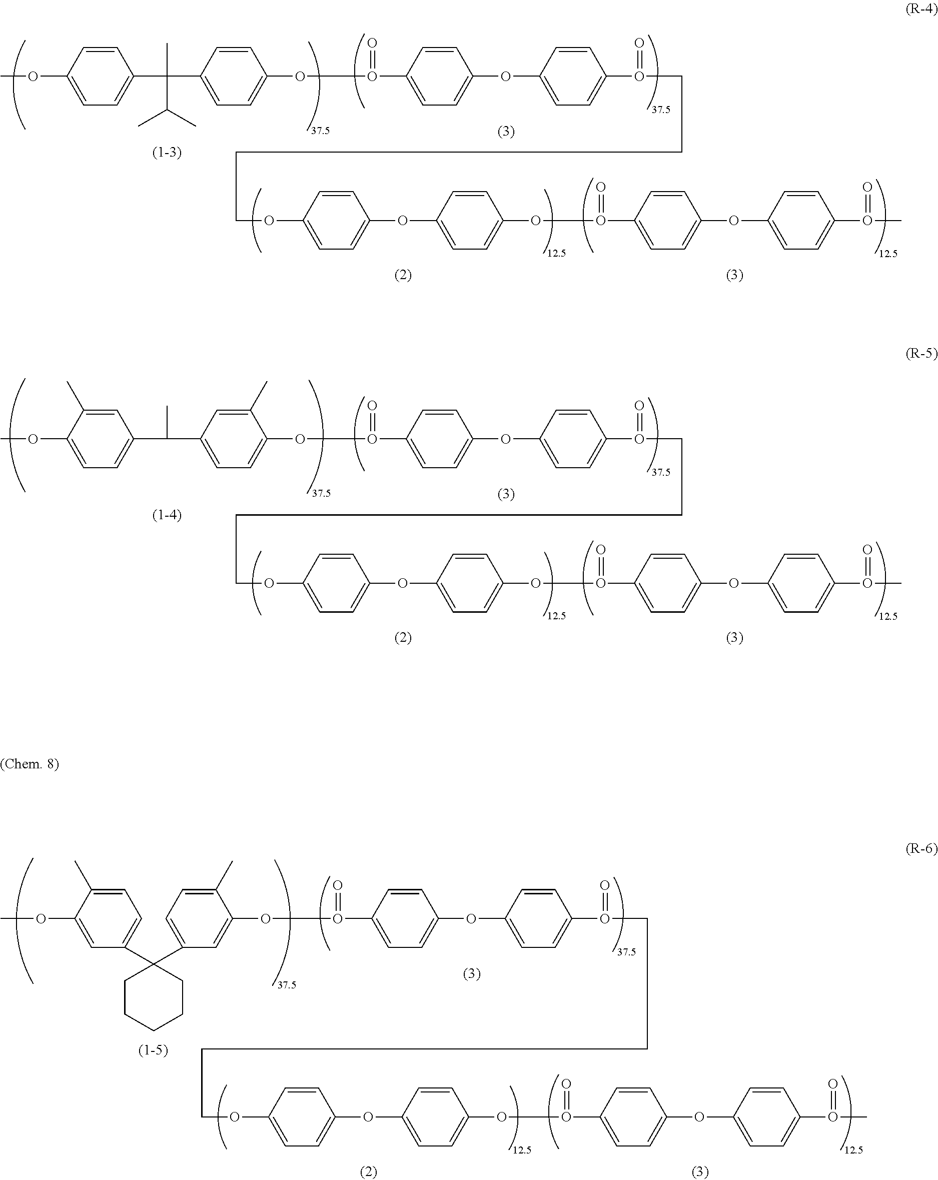

In the polyarylate resin (PA), the repeating unit derived from bisphenol and the repeating unit derived from dicarboxylic acid are adjacent and bonded to each other. The repeating unit derived from bisphenol includes, for example, the repeating units (1) and (2). Further, the repeating unit derived from dicarboxylic acid includes, for example, the repeating unit (3). The polyarylate resin (PA) may be, for example, a random copolymer, an alternating copolymer, a periodic copolymer, or a block copolymer.

The polyarylate resin (PA) may include, as repeating units, only the repeating units (1), (2), and (3). The polyarylate resin (PA) may further include, as a repeating unit, a repeating unit other than the repeating units (1), (2), and (3), in addition to the repeating units (1), (2), and (3). The charge transporting layer 3b may include only one type of polyarylate resin (PA), or may include two or more types of polyarylate resins (PA).

Specific examples of the polyarylate resin (PA) including the repeating unit other than the repeating units (1-1), (2), and (3) include a polyarylate resin represented by a chemical formula (R-7) including a repeating unit represented by the following formula (4). The repeating unit (4) may be derived from a compound (DC-4) described below. Note that in the chemical formula (R-7), the number at the bottom right of each repeating unit indicates the percentage (%) of the number of repeating units to the total number of repeating units included in the polyarylate resin.

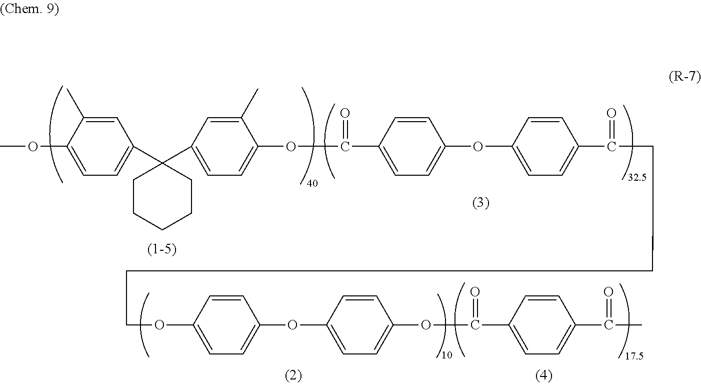

The viscosity average molecular weight of the polyarylate resin (PA) is favorably 10,000 or more, more favorably 20,000 or more, still more favorably 30,000 or more, particularly favorably 40,000 or more. When the viscosity average molecular weight of the polyarylate resin (PA) is 10,000 or more, it is possible to improve the wear resistance of the photoreceptor 1. Meanwhile, the viscosity average molecular weight of the polyarylate resin (PA) is favorably 80,000 or less, more favorably 70,000 or less. When the viscosity average molecular weight of the polyarylate resin (PA) is 80,000 or less, the polyarylate resin (PA) becomes easier to dissolve in the solvent for forming a charge transporting layer.

The method of producing the polyarylate resin (PA) is not particularly limited. Examples of the method of producing the polyarylate resin (PA) include a method of polycondensing bisphenol for forming the repeating unit derived from bisphenol and dicarboxylic acid for forming the repeating unit derived from dicarboxylic acid. For polycondensation, a known synthesis method (e.g., solution polymerization, melt polymerization, or interfacial polymerization) can be adopted.

Examples of bisphenol for forming the repeating unit derived from bisphenol in the polyarylate resin (PA) include compounds represented by a general formula (BP-1) and a chemical formula (BP-2) (hereinafter, respectively referred to as compounds (BP-1) and (BP-2) in some cases). Examples of dicarboxylic acid for forming the repeating unit derived from dicarboxylic acid in the polyarylate resin (PA) include a compound represented by a chemical formula (DC-3) (hereinafter, referred to as a compound (DC-3) in some cases). R¹, R², R³, and R⁴ in the general formula (BP-1) are respectively synonymous with R¹, R², R³, and R⁴ in the general formula (1).

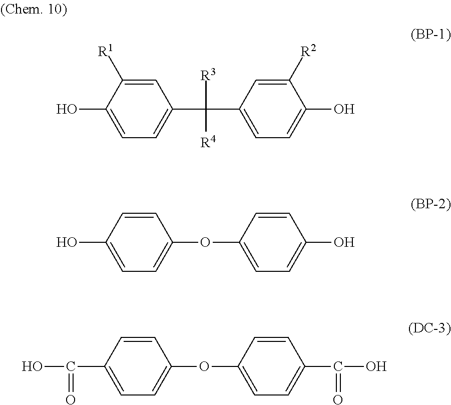

Suitable examples of the compound (BP-1) include compounds represented by chemical formulae (BP-1-1) to (BP-1-5) (hereinafter, respectively referred to as compounds (BP-1-1) to (BP-1-5) in some cases).

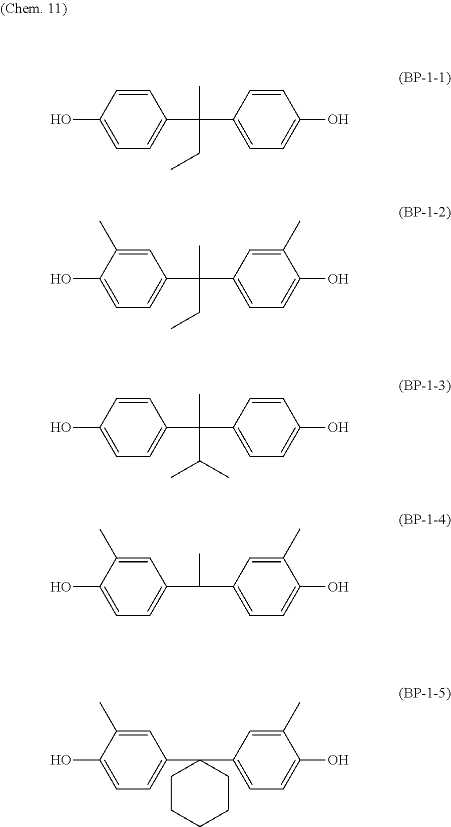 [SMILES: CCC(C)(c1ccc(O)cc1)c1ccc(O)cc1 ; CCC(C)(c1ccc(O)c(C)c1)c1ccc(O)c(C)c1 ; CC(C)C(C)(c1ccc(O)cc1)c1ccc(O)cc1 ; Cc1cc(C(C)c2ccc(O)c(C)c2)ccc1O ; Cc1cc(C2(c3ccc(O)c(C)c3)CCCCC2)ccc1O]

The bisphenol for forming the repeating unit derived from bisphenol may be derivatized to an aromatic diacetate for use. The dicarboxylic acid for forming the repeating unit derived from dicarboxylic acid may be derivatized for use. Examples of the derivative of dicarboxylic acid include a dicarboxylic acid dichloride, a dicarboxylic acid dimethyl ester, a dicarboxylic acid diethyl ester, and a dicarboxylic acid anhydride. The dicarboxylic acid dichloride is a compound obtained by substituting each of two “—C(═O)—OH” groups of dicarboxylic acid with a “—C(═O)—Cl” group.

In the polycondensation of bisphenol and dicarboxylic acid, one or both of a base and a catalyst may be added. Examples of the base include sodium hydroxide. Examples of the catalyst include benzyltributylammonium chloride, ammonium chloride, ammonium bromide, a quaternary ammonium salt, triethylamine, and trimethylamine.

The charge transporting layer 3b may include only the polyarylate resin (PA) as a binder resin. Further, the charge transporting layer 3b may further include a binder resin other than the polyarylate resin (PA) (hereinafter, referred to as a different binder resin in some cases) as a binder resin, within a range that does not inhibit the effects of the present disclosure.

Examples of the different binder resin include a thermoplastic resin (more specifically, a polycarbonate resin, a styrene resin, a styrene-butadiene copolymer, a styrene-acrylonitrile copolymer, a styrene-maleic acid copolymer, a styrene-acrylic acid copolymer, an acrylic copolymer, a polyethylene resin, an ethylene-vinyl acetate copolymer, a chlorinated polyethylene resin, a polyvinyl chloride resin, a polypropylene resin, an ionomer, a vinyl chloride-vinyl acetate copolymer, a polyester resin, an alkyd resin, a polyamide resin, a polyurethane resin, a polysulfone resin, a diallylphthalate resin, a ketone resin, a polyvinylbutyral resin, a polyvinylacetal resin, and a polyether resin), a thermosetting resin (more specifically, a silicone resin, an epoxy resin, a phenolic resin, a urea resin, a melamine resin, and a cross-linkable thermosetting resin other than these), and a photocurable resin (more specifically, an epoxy-acrylic acid resin and a urethane-acrylic acid copolymer).

### (Hole Transporting Agent)

The charge transporting layer 3b includes, as a hole transporting agent, a compound represented by the following general formula (10) (hereinafter, referred to as a hole transporting agent (10) in some cases).

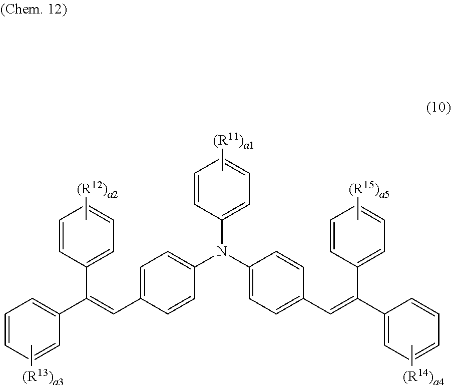

In the general formula (10), R¹¹ to R¹⁵ each independently represent an alkyl group having 1 to 8 carbon atoms or an alkoxy group having 1 to 8 carbon atoms. a1, a2, a3, a4, and a5 each independently represent an integer of 0 or more and 5 or less.

In the general formula (10), when a1 represents an integer of 2 or more and 5 or less, the plurality of R¹¹ may be the same as or different from each other. When a2 represents an integer of 2 or more and 5 or less, the plurality of R¹² may be the same as or different from each other. When a3 represents an integer of 2 or more and 5 or less, the plurality of R¹³ may be the same as or different from each other. When a4 represents an integer of 2 or more and 5 or less, the plurality of R¹⁴ may be the same as or different from each other. When a5 represents an integer of 2 or more and 5 or less, the plurality of R¹⁵ may be the same as or different from each other.

In the general formula (10), R¹¹ to R¹⁵ favorably each independently represent an alkyl group having 1 to 8 carbon atoms, more favorably an alkyl group having 1 or more and 3 or less carbon atoms, still more favorably a methyl group. a1, a2, a3, a4, and a5 favorably each independently represent 0 or 1.

Suitable examples of the hole transporting agent include compounds represented by a chemical formula (H-1) and a chemical formula (H-2) (hereinafter, respectively referred to as hole transporting agents (H-1) and (H-2) in some cases).

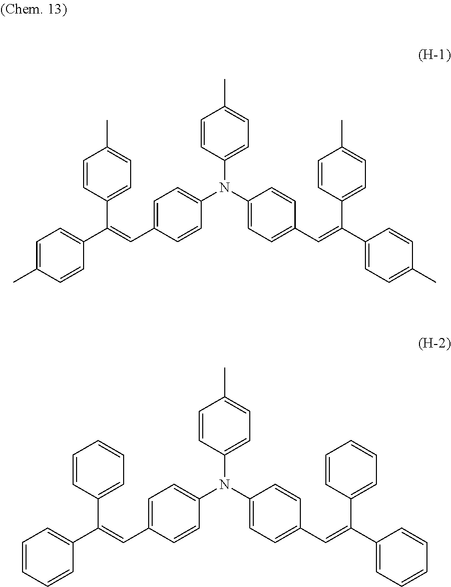

In the photoreceptor 1, the content of the hole transporting agent is favorably 10 parts by mass or more and 200 parts by mass or less, more favorably 20 parts by mass or more and 100 parts by mass or less, still more favorably 40 parts by mass or more and 50 parts by mass or less, with respect to 100 parts by mass of the binder resin.

The photosensitive layer 3 may include only the one type of hole transporting agent, or may include two or more types of hole transporting agents.

The photosensitive layer 3 may include a hole transporting agent other than that represented by the general formula (10) within a range that does not inhibit the effects of the present disclosure. Examples of the different hole transporting agent include a triphenylamine derivative other than that represented by the general formula (10), a diamine derivative (e.g., an N,N,N′,N′-tetraphenylbenzidine derivative, an N,N,N′,N′-tetraphenylphenylenediamine derivative, an N,N,N′,N′-tetraphenylnaphthylenediamine derivative, an N,N,N′,N′-tetraphenylphenanthrylenediamine derivative, and a di(aminophenylethenyl)benzene derivative), an oxadiazole compound (e.g., 2,5-di(4-methylaminophenyl)-1,3,4-oxadiazole), a styryl compound (e.g., 9-(4-diethylaminostyryl)anthracene), a carbazole compound (e.g., polyvinylcarbazole), an organic polysilane compound, a pyrazoline compound (e.g., 1-phenyl-3-(p-dimethylaminophenyl)pyrazoline), a hydrazone compound, an indole compound, an oxazole compound, an isooxazole compound, a thiazole compound, a thiadiazole compound, an imidazole compound, a pyrazole compound, and a triazole compound.

### (Phthalocyanine Pigment)

The phthalocyanine pigment included in the charge transporting layer 3b is metal-free phthalocyanine or a compound (phthalocyanine) represented by a general formula (11). Hereinafter, the “compound represented by the general formula (11)” will be referred to as a “phthalocyanine pigment (11)” in some cases. Further, the “metal-free phthalocyanine or phthalocyanine pigment (11)” will be referred to as a “predetermined phthalocyanine pigment” in some cases.

First, the phthalocyanine pigment (11) will be described. In the following general formula (11), M represents a metal atom that may have a ligand.

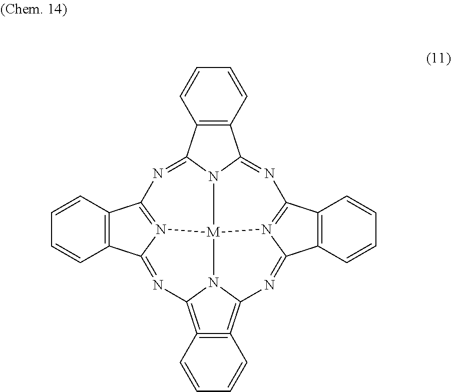

In the general formula (11), the metal atom represented by M is favorably a titanium atom, a gallium atom, a copper atom, a zinc atom, or a lead atom, more favorably a titanium atom or a gallium atom, still more favorably a titanium atom.

In the general formula (11), the metal atom represented by M may have a ligand. Examples of such a ligand include an alkyl group having 1 or more and 6 or less carbon atoms, an alkoxy group having 1 or more and 6 or less carbon atoms, an aryloxy group having 6 or more and 14 or less carbon atoms, a halogen atom, a hydroxy group, and an oxo group (═O). Of these, a ligand other than the oxo group coordinates, two ligands may coordinate to the metal atom. As the ligand, a halogen atom (more favorably, a chlorine atom), a hydroxy group, or an oxo group is favorable.

In the general formula (11), M represents favorably a titanium atom that may have a ligand, a gallium atom that may have a ligand, a copper atom that may have a ligand, a zinc atom that may have a ligand, or a lead atom that may have a ligand, more favorably a titanium atom that may have a ligand or a gallium atom that may have a ligand, still more favorably a titanium atom having a ligand or a gallium atom having a ligand. As the titanium atom having a ligand, a titanium atom having an oxygen atom as a ligand (i.e., TiO) is favorable. As the gallium atom having a ligand, a gallium atom having a chlorine atom as a ligand (i.e., GaCl) or a gallium atom having a hydroxy group as a ligand (i.e., GaOH) is favorable.

The phthalocyanine pigment (11) may be crystalline or non-crystalline. As the phthalocyanine pigment (11), for example, titanyl phthalocyanine, hydroxygallium phthalocyanine, or chlorogallium phthalocyanine is favorable, and titanyl phthalocyanine is more favorable. Titanyl phthalocyanine is a compound represented by a formula (K-1) (hereinafter, referred to as a phthalocyanine pigment (K-1) in some cases). Note that although the formula (K-1) is the same as a formula (CGM-1) described below, titanyl phthalocyanine included in the charge transporting layer 3b is represented by the formula (K-1) and titanyl phthalocyanine that may be included in the charge generating layer 3a is represented by the formula (CGM-1) in order to distinguish them. Examples of the crystal of the titanyl phthalocyanine include a-type, P-type, and Y-type crystals of the titanyl phthalocyanine.

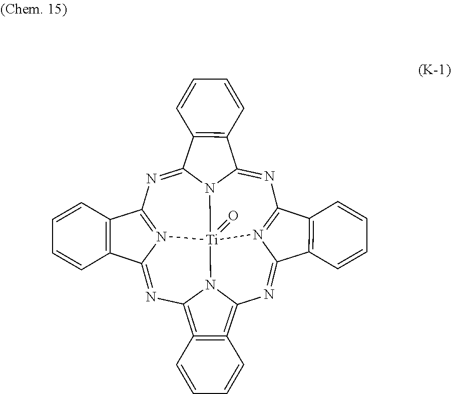

Next, metal-free phthalocyanine will be described. Metal-free phthalocyanine is a compound represented by a formula (K-2) (hereinafter, referred to as a phthalocyanine pigment (K-2) in some cases). Note that although the formula (K-2) is the same as a formula (CGM-2) described below, metal-free phthalocyanine included in the charge transporting layer 3b is represented by the formula (K-2) and metal-free phthalocyanine that may be included in the charge generating layer 3a is represented by the formula (CGM-2) in order to distinguish them. The metal-free phthalocyanine may be crystalline or non-crystalline. Examples of the crystal of metal-free phthalocyanine include an X-type crystal of metal-free phthalocyanine.

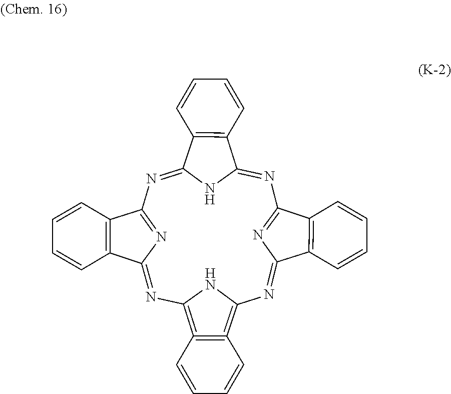

The content of the predetermined phthalocyanine pigment is favorably 0.10 parts by mass or more and 0.60 parts by mass or less, more favorably 0.15 parts by mass or more and 0.50 parts by mass or less, with respect to 100.00 parts by mass of the binder resin.

In the case where the content of the predetermined phthalocyanine pigment is 0.10 parts by mass or more with respect to 100.00 parts by mass of the binder resin, and further in the case where it is 0.15 parts by mass or more, charges are favorably generated from the predetermined phthalocyanine pigment during exposure and the charges accumulated in the charge transporting layer 3b can be cancelled out more effectively, thereby suppressing the occurrence of an image memory and fogging more effectively and further improving sensitivity characteristics, particularly sensitivity characteristics when printing a solid image and sensitivity characteristics when printing a halftone image.

Meanwhile, in the case where the content of the predetermined phthalocyanine pigment exceeds 0.60 parts by mass with respect to 100.00 parts by mass of the binder resin, during exposure of the photoreceptor 1, the exposure light tends to be blocked by the charge transporting layer 3b, making it difficult to reach the charge generating layer 3a. When the content of the predetermined phthalocyanine pigment is 0.60 parts by mass or less with respect to 100.00 parts by mass of the binder resin, the exposure light is less likely to be blocked by the charge transporting layer 3b and reaches the charge generating layer 3a favorably. As a result, it is possible to cancel out the charges accumulated in the charge transporting layer 3b more effectively. Further, it is possible to further improve sensitivity characteristics, particularly sensitivity characteristics when printing a solid image and sensitivity characteristics when printing a halftone image. This effect becomes more significant when the content of the predetermined phthalocyanine pigment is 0.50 parts by mass or less.

The charge transporting layer 3b may include only one type, of metal-free phthalocyanine and the phthalocyanine pigment (11), or may include two or more types. In the case where two or more types, of metal-free phthalocyanine and the phthalocyanine pigment (11), are included, the content of the predetermined phthalocyanine pigment means the total content of the two or more types, of metal-free phthalocyanine and the phthalocyanine pigment (11).

In order to further improve the sensitivity characteristics of the photoreceptor 1, it is favorable that the predetermined phthalocyanine pigment included in the charge transporting layer 3b is the same as the charge generating agent included in the charge generating layer 3a.

### (Additive)

Examples of the additive include an ultraviolet absorber, an antioxidant, a radical scavenger, a singlet quencher, a softener, a surface modifier, a bulking agent, a thickener, a dispersion stabilizer, a wax, a donor, a surfactant, a plasticizer, a sensitizer, an electron acceptor compound, and a leveling agent. As the leveling agent, silicone oil is favorable and silicone oil having a dimethylpolysiloxane structure is more favorable.

### (Material Combination)

In order to improve the wear resistance of the photoreceptor and suppress image defects such as fogging and an image memory in the formed image, it is favorable that the combination of the polyarylate resin, the hole transporting agent, and the phthalocyanine pigment included in the charge transporting layer 3b is any of combinations No. F1 to F24 shown in Table 1. In particular, the phthalocyanine pigment is favorably titanyl phthalocyanine, more favorably Y-type titanyl phthalocyanine.

TABLE 1

| No. | Resin | HTM | Phthalocyanine pigment |
|---|---|---|---|
| F1 | I | H-1 | K-1 |
| F2 | I | H-1 | K-2 |
| F3 | I | H-2 | K-1 |
| F4 | I | H-2 | K-2 |
| F5 | II | H-1 | K-1 |
| F6 | II | H-1 | K-2 |
| F7 | II | H-2 | K-1 |
| F8 | II | H-2 | K-2 |
| F9 | III | H-1 | K-1 |
| F10 | III | H-1 | K-2 |
| F11 | III | H-2 | K-1 |
| F12 | III | H-2 | K-2 |
| F13 | IV | H-1 | K-1 |
| F14 | IV | H-1 | K-2 |
| F15 | IV | H-2 | K-1 |
| F16 | IV | H-2 | K-2 |
| F17 | V | H-1 | K-1 |
| F18 | V | H-1 | K-2 |
| F19 | V | H-2 | K-1 |
| F20 | V | H-2 | K-2 |
| F21 | VI | H-1 | K-1 |
| F22 | VI | H-1 | K-2 |
| F23 | VI | H-2 | K-1 |
| F24 | VI | H-2 | K-2 |

In order to improve the wear resistance of the photoreceptor 1 and suppress image defects such as fogging and an image memory on the formed image, the combination of the polyarylate resin, the hole transporting agent, and the phthalocyanine pigment included in the charge transporting layer 3b is any of combinations No. G1 to G28 shown in Table 1. In particular, the phthalocyanine pigment is favorably titanyl phthalocyanine, more favorably Y-type titanyl phthalocyanine. Note that the polyarylate resins (R-1) to (R-7) will be described in Example in detail.

TABLE 2

| No. | Resin | HTM | Phthalocyanine pigment |
|---|---|---|---|
| G1 | R-1 | H-1 | K-1 |
| G2 | R-1 | H-1 | K-2 |
| G3 | R-1 | H-2 | K-1 |
| G4 | R-1 | H-2 | K-2 |
| G5 | R-2 | H-1 | K-1 |
| G6 | R-2 | H-1 | K-2 |
| G7 | R-2 | H-2 | K-1 |
| G8 | R-2 | H-2 | K-2 |
| G9 | R-3 | H-1 | K-1 |
| G10 | R-3 | H-1 | K-2 |
| G11 | R-3 | H-2 | K-1 |
| G12 | R-3 | H-2 | K-2 |
| G13 | R-4 | H-1 | K-1 |
| G14 | R-4 | H-1 | K-2 |
| G15 | R-4 | H-2 | K-1 |
| G16 | R-4 | H-2 | K-2 |
| G17 | R-5 | H-1 | K-1 |
| G18 | R-5 | H-1 | K-2 |
| G19 | R-5 | H-2 | K-1 |
| G20 | R-5 | H-2 | K-2 |
| G21 | R-6 | H-1 | K-1 |
| G22 | R-6 | H-1 | K-2 |
| G23 | R-6 | H-2 | K-1 |
| G24 | R-6 | H-2 | K-2 |
| G25 | R-7 | H-1 | K-1 |
| G26 | R-7 | H-1 | K-2 |
| G27 | R-7 | H-2 | K-1 |
| G28 | R-7 | H-2 | K-2 |

In Tables 1 and 2 above, “No.” indicates the “combination No.”, “HTM” indicates the “hole transporting agent”, and “Resin” indicates the “polyarylate resin”.

In particular, the electrophotographic photoreceptor 1 according to the embodiment of the present disclosure favorably includes a binder resin including one or more types of polyarylate resins (R-1) to (R-7), a hole transporting agent including one or more types of hole transporting agents (H-1) and (H-2), and the phthalocyanine pigment (K-1).

### [Charge Generating Layer]

The charge generating layer 3a typically includes a charge generating agent. Further, the charge generating layer 3a may include a base resin as necessary. The charge generating layer 3a may include an additive as necessary. The thickness of the charge generating layer 3a is not particularly limited, but is favorably 0.01 μm or more and 5 μm or less, more favorably 0.1 μm or more and 3 μm or less. The charge generating layer 3a is, for example, a single layer.

### (Charge Generating Agent)

Examples of the charge generating agent included in the charge generating layer 3a include a phthalocyanine pigment, a perylene pigment, a bisazo pigment, a trisazo pigment, a dithioketopyrrolopyrrole pigment, a metal-free naphthalocyanine pigment, a metal naphthalocyanine pigment, a squaraine pigment, an indigo pigment, an azulenium pigment, a cyanine pigment, a powder of an inorganic photoconductive material (e.g., selenium, selenium-tellurium, selenium-arsenic, cadmium sulfide, and amorphous silicon), a pyrylium pigment, an anthanthron pigment, a triphenylmethane pigment, a threne pigment, a toluidine pigment, a pyrazoline pigment, and a quinacridone pigment. The photosensitive layer 3 may include only one type of charge generating agent or may include two or more types of charge generating agents.

The phthalocyanine pigment is a pigment having a phthalocyanine structure. Examples of the phthalocyanine pigment include metal-free phthalocyanine and metal phthalocyanine. Examples of the metal phthalocyanine include titanyl phthalocyanine, hydroxygallium phthalocyanine, and chlorogallium phthalocyanine. Metal-free phthalocyanine is represented by the formula (CGM-1). Titanyl phthalocyanine is represented by the formula (CGM-2).

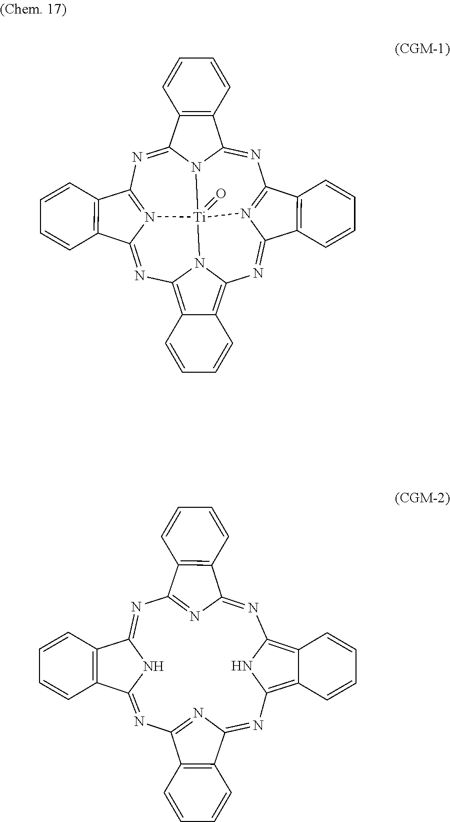

The phthalocyanine pigment may be crystalline or non-crystalline. Examples of the crystal of the metal-free phthalocyanine include an X-type crystal of the metal-free phthalocyanine (hereinafter, referred to as an X-type metal-free phthalocyanine in some cases). Examples of the crystal of the titanyl phthalocyanine include a-type, p-type, and Y-type crystals of the titanyl phthalocyanine (hereinafter, respectively referred to as a-type, p-type, and Y-type titanyl phthalocyanines in some cases).

For example, for a digital optical image forming apparatus (e.g., a laser beam printer or a facsimile machine using a light source such as semiconductor laser light), it is favorable to use a photoreceptor having sensitivity in a wavelength region of 700 nm or more. As the charge generating agent, a phthalocyanine pigment is favorable, metal-free phthalocyanine or titanyl phthalocyanine is more favorable, titanyl phthalocyanine is still more favorable, and Y-type titanyl phthalocyanine is particularly favorable because they have a high quantum yield in the wavelength region of 700 nm or more.

The Y-type titanyl phthalocyanine has a main peak at, for example, 27.2° of the Bragg angle (20+0.2°) in the CuKα characteristic X-ray diffraction spectrum. The main peak in the CuKα characteristic X-ray diffraction spectrum is a peak having the first or second highest intensity in the range of the Bragg angle (20±0.2°) of 3° or more and 400 or less. The Y-type titanyl phthalocyanine does not have a peak at 26.2° in the CuKα characteristic X-ray diffraction spectrum.

The CuKα characteristic X-ray diffraction spectrum can be measured by, for example, the following method. First, a sample holder of an X-ray diffractometer (e.g., “RINT (registered trademark) 1100” manufactured by Rigaku Holdings Corporation and its Global Subsidiaries) is filled with a sample (titanyl phthalocyanine) to measure the X-ray diffraction spectrum under the conditions of an X-ray tube Cu, a tube voltage of 40 kV, a tube current of 30 mA, and a wavelength of CuKα characteristic X-rays of 1.542 Å. The measurement range (20) is, for example, 3° or more and 400 or less (start angle of 3°, stop angle of 40°), and the scanning speed is, for example, 10°/min. The main peak is determined from the obtained X-ray diffraction spectrum, and the Bragg angle of the main peak is read.

The content of the charge generating agent is favorably 10 parts by mass or more and 300 parts by mass or less, more favorably 100 parts by mass or more and 200 parts by mass or less, with respect to 100 parts by mass of the base resin.

### (Base Resin)

The charge generating layer 3a may include a base resin. Examples of the base resin are the same as the examples of the different binder resin included in the charge transporting layer 3b.

### (Additive)

Examples of the additive included in the photosensitive layer 3 (more specifically, the charge generating layer 3a and the charge transporting layer 3b) include an ultraviolet absorber, an antioxidant, a radical scavenger, a singlet quencher, a softener, a surface modifier, a bulking agent, a thickener, a dispersion stabilizer, a wax, a donor, a surfactant, a plasticizer, a sensitizer, an electron acceptor compound, and a leveling agent.

### [Conductive Base]

The conductive base 2 is not particularly limited as long as it can be used as a conductive base of the photoreceptor 1. The conductive base 2 only needs to have at least a surface portion formed of a material having conductivity. Examples of the conductive base 2 include a conductive base formed of a material having conductivity. Other examples of the conductive base 2 include a conductive base covered with a material having conductivity. Examples of the material having conductivity include aluminum, iron, copper, tin, platinum, silver, vanadium, molybdenum, chromium, cadmium, titanium, nickel, palladium, indium, stainless steel, and brass. These materials having conductivity may be used alone, or two or more of them may be used in combination (e.g., as an alloy). Of these material having conductivity, aluminum and an aluminum alloy are favorable because they allow charges to favorably transfer from the photosensitive layer 3 to the conductive base 2.

The shape of the conductive base 2 is appropriately selected in accordance with the structure of the image forming apparatus. Examples of the shape of the conductive base 2 include a sheet shape and a drum shape. Further, the thickness of the conductive base 2 is appropriately selected in accordance with the shape of the conductive base 2.

### [Intermediate Layer]

The intermediate layer 4 (undercoat layer) includes, for example, an inorganic particle and a resin used for the intermediate layer 4 (intermediate layer resin). The presence of the intermediate layer 4 makes the flow of currents generated when the photoreceptor 1 is exposed smooth and makes it possible to suppress an increase in resistance, while maintaining the insulated state to the extent that leakage can be suppressed.

Examples of the inorganic particle include a particle of metal (e.g., aluminum, iron, and copper), a particle of a metal oxide (e.g., titanium oxide, alumina, zirconium oxide, tin oxide, and zinc oxide), and a particle of a non-metal oxide (e.g., silica). These inorganic particles may be used alone, or two or more of them may be used in combination.

Examples of the intermediate layer resin are favorably the same as the examples of the different binder resin included in the charge transporting layer 3b. The intermediate layer 4 may include an additive. Examples of the additive included in the intermediate layer 4 are favorably the same as the examples of the additive included in the photosensitive layer 3.

### (Method of Producing Photoreceptor)

An example of the method of producing the photoreceptor 1 will be described. The method of producing the photoreceptor 1 includes a charge generating layer forming step and a charge transporting layer forming step. In the charge generating layer forming step, first, a coating liquid for forming the charge generating layer 3a (hereinafter, referred to as a coating liquid for a charge generating layer in some cases) is prepared. The coating liquid for a charge generating layer is applied onto the conductive base 2. Subsequently, at least part of the solvent included in the applied coating liquid for a charge generating layer is removed to form the charge generating layer 3a. The coating liquid for a charge generating layer includes, for example, a charge generating agent, a base resin, and a solvent. Such a coating liquid for a charge generating layer is prepared by dissolving or dispersing the charge generating agent and the base resin in the solvent. The coating liquid for a charge generating layer may further include an additive as necessary.

In the charge transporting layer forming step, first, a coating liquid for forming the charge transporting layer 3b (hereinafter, referred to as a coating liquid for a charge transporting layer in some cases) is prepared. The coating liquid for a charge transporting layer is applied onto the charge generating layer. Subsequently, at least part of the solvent included in the applied coating liquid for a charge transporting layer is removed to form a charge transporting layer. The coating liquid for a charge transporting layer includes a hole transporting agent, a binder resin, and a solvent. The coating liquid for a charge transporting layer can be prepared by dissolving or dispersing the hole transporting agent and the binder resin in the solvent. The coating liquid for a charge transporting layer may further include an additive as necessary.

The solvent included in the coating liquid for a charge generating layer and the coating liquid for a charge transporting layer (hereinafter, collectively referred to as a coating liquid in some cases) is not particularly limited as long as it is capable of dissolving or dispersing each component included in the coating liquid. Examples of the solvent include an alcohol (more specifically, methanol, ethanol, isopropanol, butanol, and the like), an aliphatic hydrocarbon (more specifically, n-hexane, octane, cyclohexane, and the like), an aromatic hydrocarbon (more specifically, benzene, toluene, xylene, and the like), a halogenated hydrocarbon (more specifically, dichloromethane, dichloroethane, carbon tetrachloride, chlorobenzene, and the like), an ether (more specifically, dimethyl ether, diethyl ether, tetrahydrofuran, ethylene glycol dimethyl ether, diethylene glycol dimethyl ether, and the like), a ketone (more specifically, acetone, methyl ethyl ketone, cyclohexanone, and the like), an ester(more specifically, ethyl acetate, methyl acetate, and the like), dimethylformaldehyde, dimethylformamide, and dimethylsulfoxide. These solvents may be used alone, or two or more of them may be used in combination.

The solvent included in the coating liquid for a charge transporting layer is favorably different from the solvent included in the coating liquid for a charge generating layer. This is because when the coating liquid for a charge transporting layer is applied onto the charge generating layer, it is favorable that the charge generating layer is not dissolved in the solvent in the coating liquid for a charge transporting layer.

The coating liquid is prepared by mixing the respective components and dispersing them in the solvent. For the mixing or dispersion, for example, a bead mill, a roll mill, a ball mill, an attrition mil, a paint shaker, or an ultrasonic disperser can be used.

The method of applying the coating liquid is not particularly limited as long as the coating liquid can be uniformly applied. Examples of the application method include a dip coating method, a spray coating method, a spin coating method, and a bar coating method.

Examples of the method of removing at least part of the solvent included in the coating liquid include heating, reduction of pressure, and a combination of heating and reduction of pressure. More specifically, a method of performing heat treatment (hot air drying) using a high-temperature dryer or a reduced-pressure dryer may be used. The temperature of the heat treatment is, for example, 40° C. or more and 150° C. or less. The time for the heat treatment is, for example, 3 minutes or more and 120 minutes or less.

Note that the method of producing the photoreceptor 1 may further include, as necessary, a step of forming the intermediate layer 4. For the step of forming the intermediate layer 4, a known method can be appropriately selected.

### Second Embodiment: Image Forming Apparatus

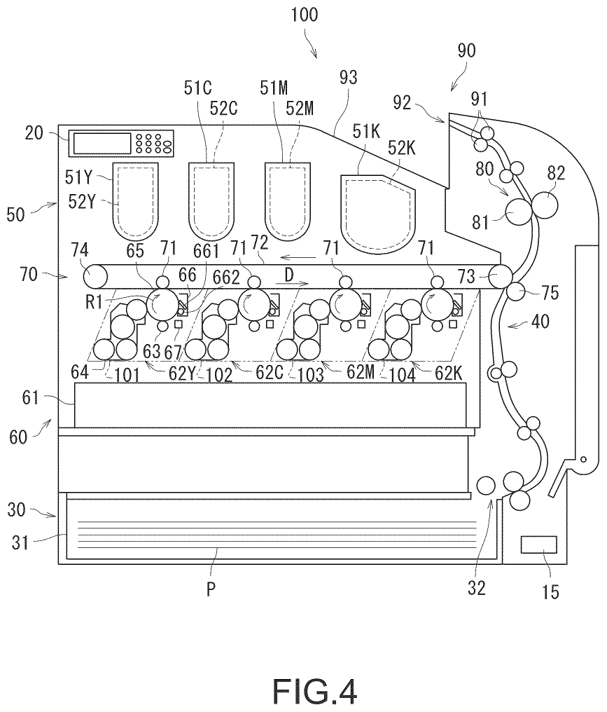

Next, an image forming apparatus 100 according to a second embodiment of the present disclosure will be described with reference to FIG. 4. FIG. 4 is a diagram showing an example of the configuration of the image forming apparatus 100. The image forming apparatus 100 is, for example, a tandem-type color printer.

As shown in FIG. 4, the image forming apparatus 100 includes a control unit 10, an operation unit 20, a paper feed unit 30, a conveying unit 40, a toner supply unit 50, an image forming unit 60, a transfer device 70, a fixing device 80, and an output unit 90.

The control unit 10 controls the operations of the respective units included in the image forming apparatus 100. The control unit 10 includes a processor (not shown) and a storage unit (not shown). The processor includes, for example, a central processing unit (CPU). The storage unit may include a memory such as a semiconductor memory, and may include a hard disk drive (HDD). The processor executes a control program to control the operation of the image forming apparatus 100. The storage unit stores the control program.

The operation unit 20 accepts an instruction from a user. Upon accepting the instruction from a user, the operation unit 20 transmits a signal indicating the instruction from a user to the control unit 10. As a result, an image forming operation by the image forming apparatus 100 is started.

The paper feed unit 30 includes a paper feed cassette 31 and a paper feed roller group 32. The paper feed cassette 31 is capable of housing a plurality of recording media P (e.g., sheets of paper). The paper feed roller group 32 feeds the recording media P housed in the paper feed cassette 31 to the conveying unit 40 one sheet at a time.

The conveying unit 40 includes a roller and a guide member. The conveying unit 40 extends from the paper feed unit 30 to the output unit 90. The conveying unit 40 conveys the recording medium P from the paper feed unit 30 to the output unit 90 through the image forming unit 60 and the fixing device 80.

The toner supply unit 50 supplies a toner to the image forming unit 60. The toner supply unit 50 includes a first mounting portion 51Y, a second mounting portion 51C, a third mounting portion 51M, and a fourth mounting portion 51K.

A first toner container 52Y is mounted on the first mounting portion 51Y. Similarly, a second toner container 52C, a third toner container 52M, and a fourth toner container 52K are respectively mounted on the second mounting portion 51C, the third mounting portion 51M, and the fourth mounting portion 51K.

A toner is housed in each of the first toner container 52Y, the second toner container 52C, the third toner container 52M, and the fourth toner container 52K. In the second embodiment, a yellow toner is housed in the first toner container 52Y. A cyan toner is housed in the second toner container 52C. A magenta toner is housed in the third toner container 52M. A black toner is housed in the fourth toner container 52K.

The image forming unit 60 includes an exposure device 61, a first image formation unit 62Y, a second image formation unit 62C, a third image formation unit 62M, and a fourth image formation unit 62K.

Each of the first image formation unit 62Y to the fourth image formation unit 62K includes a charging device 63, a development device 64, an image carrier 65, a cleaning device 66, and a static elimination device 67.

Note that regarding the configurations of the first image formation unit 62Y to the fourth image formation unit 62K, only the type of toner to be supplied from the toner supply unit 50 differs and the other configurations are the same. For this reason, in FIG. 4, the configuration of each of the second image formation unit 62C to the fourth image formation unit 62K is shown with reference symbols omitted.

The image carrier 65 is the photoreceptor 1 according to the first embodiment. As described in the first embodiment, the photoreceptor 1 according to the first embodiment includes the photosensitive layer 3 that is favorably formed, has excellent wear resistance, and is capable of suppressing image defects caused by fogging and an image memory. Therefore, the image forming apparatus 100 according to the second embodiment includes the photoreceptor 1 that is the image carrier 65, which includes the photosensitive layer 3 that is favorably formed, and is capable of improving wear resistance and suppressing image defects caused by fogging and an image memory.

Now, the presumed reason why the occurrence of fogging is suppressed by the predetermined hole transporting agent will be described using the above the image forming apparatus 100. Specifically, the image forming apparatus 100 in which a reversal development method is adopted, the charging device charges the photoreceptor 1 to negative polarity, and an electrostatic latent image is developed by the negatively charged toner (more specifically, a toner that is a non-magnetic one-component developer) will be described as an example. During development, the negatively charged is placed on the development member of the development device 64 included in the image forming apparatus 100. When the negatively charged toner on the development member comes into contact with the photoreceptor, the negative chargeability of the negatively charged toner decreases and the negatively charged toner is reversely charged to positive polarity in some cases. Part of the toner on the development member, which has not been used for forming an image, returns to the development device 64 and is used for development again. When used for development again, the toner whose negative chargeability has decreased and the toner reversely charged due to the contact with the photoreceptor 1 tend to adhere to a blank portion of the formed image. For this reason, fogging occurs in the formed image. In the case where the charge transporting layer 3b includes the predetermined hole transporting agent, it is possible to prevent the negative chargeability of the negatively charged toner from decreasing and the negatively charged toner from being reversely charged to positive polarity even when the toner comes into contact with the photoreceptor 1. Therefore, it is possible to suppress the occurrence of fogging in the formed image.

The charging device 63, the development device 64, the cleaning device 66, and the static elimination device 67 are disposed along the circumferential surface of the image carrier 65. In the second embodiment, the image carrier 65 rotates in a direction indicated by an arrow in FIG. 4 (clockwise direction).

The charging device 63 charges the surface (circumferential surface) of the image carrier 65. The charging device 63 uniformly charges the image carrier 65 to predetermined polarity by electric discharge. In the second embodiment, the charging device 63 charges the image carrier 65 to positive polarity. The charging device 63 is, for example, a charging roller.

The exposure device 61 exposes the charged surface of the image carrier 65. In detail, the exposure device 61 applies laser light to the charged surface of the image carrier 65. In this way, an electrostatic latent image is formed on the surface of the image carrier 65.

A toner is supplied from the toner supply unit 50 to the development device 64. The development device 64 supplies the toner supplied from the toner supply unit 50 to the surface of the image carrier 65. As a result, the electrostatic latent image formed on the surface of the image carrier 65 is developed as a toner image.

In the second embodiment, the development device 64 of the first image formation unit 62Y is connected to the first toner container 52Y. For this reason, a yellow toner is supplied to the development device 64 of the first image formation unit 62Y. Therefore, a yellow toner image is formed on the surface of the image carrier 65 of the first image formation unit 62Y.

Similarly, the development device 64 of the second image formation unit 62C, the development device 64 of the third image formation unit 62M, and the development device 64 of the fourth image formation unit 62K are respectively connected to the second toner container 52C, the third toner container 52M, and the fourth toner container 52K. For this reason, a cyan toner, a magenta toner, and a black toner are respectively supplied to the development device 64 of the second image formation unit 62C, the development device 64 of the third image formation unit 62M, and the development device 64 of the fourth image formation unit 62K. Therefore, a cyan toner image, a magenta toner image, and a black toner image are respectively formed on the surface of the image carrier 65 of the second image formation unit 62C, the surface of the image carrier 65 of the third image formation unit 62M, and the surface of the image carrier 65 of the fourth image formation unit 62K.

The cleaning device 66 includes a cleaning member 661 and a rubbing roller 662. After transfer by a primary transfer roller 71 described below, the cleaning device 66 collects the toner adhering to the surface of the image carrier 65. In detail, the cleaning device 66 causes the cleaning member 661 to be pressed against the surface of the image carrier 65 to collect the toner adhering to the surface of the image carrier 65. The cleaning member 661 is, for example, a cleaning blade. The rubbing roller 662 rubs the surface of the image carrier 65 to polish the surface of the image carrier 65.

The static elimination device 67 applies static elimination light to the surface of the image carrier 65 to eliminate static electricity on the surface of the image carrier 65.

The transfer device 70 transfers a toner image from the image carrier 65 to the recording medium P that is a to-be-transferred body. In detail, the transfer device 70 transfers each toner image formed on the surface of each image carrier 65 of the first image formation unit 62Y to the fourth image formation unit 62K onto the recording medium P in a superimposed manner. In the second embodiment, the transfer device 70 transfers each toner image onto the recording medium P in a superimposed manner using a secondary transfer method (intermediate transfer method). The transfer device 70 includes four primary transfer rollers 71, an intermediate transfer belt 72, a drive roller 73, a driven roller 74, and a secondary transfer roller 75.

The intermediate transfer belt 72 is an endless belt stretched over the four primary transfer rollers 71, the drive roller 73, and the driven roller 74. The intermediate transfer belt 72 is driven in accordance with rotation of the drive roller 73. The intermediate transfer belt 72 rotates counterclockwise in FIG. 4. The driven roller 74 is driven to rotate in accordance with the drive of the intermediate transfer belt 72.

The first image formation unit 62Y to the fourth image formation unit 62K are disposed to face the lower surface of the intermediate transfer belt 72. In the second embodiment, the first image formation unit 62Y to the fourth image formation unit 62K are disposed in the order of the first image formation unit 62Y to the fourth image formation unit 62K from the upstream side to the downstream side in a drive direction D of the lower surface of the intermediate transfer belt 72.

Each primary transfer roller 71 is disposed to face the corresponding image carrier 65 via the intermediate transfer belt 72 and is pressed toward the image carrier 65. For this reason, the toner image formed on the surface of each image carrier 65 by each primary transfer roller 71 is sequentially transferred onto the intermediate transfer belt 72. In the second embodiment, a yellow toner image, a cyan toner image, a magenta toner image, and a black toner image are transferred onto the intermediate transfer belt 72 in this order in a superimposed manner. Hereinafter, the toner image obtained by superimposing a yellow toner image, a cyan toner image, a magenta toner image, and a black toner image will be referred to as a “stacked toner image” in some cases.

The secondary transfer roller 75 is disposed to face the drive roller 73 via the intermediate transfer belt 72. The secondary transfer roller 75 is pressed toward the drive roller 73. This forms a transfer nip between the secondary transfer roller 75 and the drive roller 73. When the recording medium P passes through the transfer nip, the stacked toner image on the intermediate transfer belt 72 is transferred onto the recording medium P by the secondary transfer roller 75. In the second embodiment, a yellow toner image, a cyan toner image, a magenta toner image, and a black toner image are transferred onto the recording medium P in this order as the top layer to the bottom layer. The recording medium P onto which the stacked toner image has been transferred is conveyed toward the fixing device 80 by the conveying unit 40.

The fixing device 80 includes a heating member 81 and a pressure member 82. The heating member 81 and the pressure member 82 are disposed to face each other to form a fixing nip. The recording medium P conveyed from the image forming unit 60 is pressurized while being heated at a predetermined fixing temperature by passing through the fixing nip. As a result, the stacked toner image is fixed to the recording medium P. The recording medium P is conveyed from the fixing device 80 to the output unit 90 by the conveying unit 40.

The output unit 90 includes an output roller pair 91 and an output tray 93. The output roller pair 91 conveys the recording medium P to the output tray 93 via an output port 92. The output port 92 is formed in the upper part of the image forming apparatus 100.

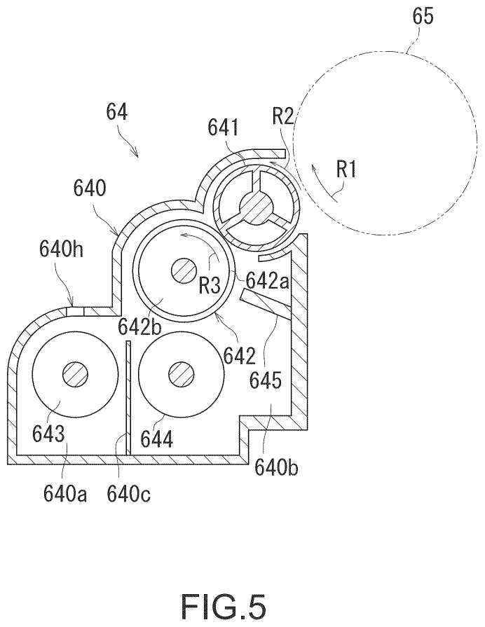

Next, the configuration of the development device 64 will be described in detail with reference to FIG. 5. FIG. 5 is a diagram showing an example of the configuration of the development device 64. In detail, FIG. 5 shows the development device 64 of the first image formation unit 62Y. Note that in FIG. 5, the image carrier 65 is illustrated with a two-dot chain line for ease of understanding. In the second embodiment, the development device 64 adopts a two-component development method using a two-component developer and a touch-down development method.

As described above with reference to FIG. 4, a development container 640 of the development device 64 is connected to the first toner container 52Y. Therefore, a yellow toner is supplied to the development container 640 of the development device 64 via a toner supply port 640h.

As shown in FIG. 5, the development device 64 includes, inside the development container 640, a development roller 641, a magnetic roller 642, a first stirring screw 643, a second stirring screw 644, and a blade 645. In detail, the development roller 641 is disposed to face the magnetic roller 642. The magnetic roller 642 is disposed to face the second stirring screw 644. The blade 645 is disposed to face the magnetic roller 642.

The development container 640 is divided into a first stirring chamber 640a and a second stirring chamber 640b by a partition wall 640c. The partition wall 640c extends in the axial direction of the development roller 641. The first stirring chamber 640a and the second stirring chamber 640b communicate with each other on the outside at both ends of the partition wall 640c in the longitudinal direction.

The first stirring screw 643 is disposed in the first stirring chamber 640a. A carrier that is a magnetic material is housed in the first stirring chamber 640a. A toner that is a non-magnetic material is supplied to the first stirring chamber 640a via the toner supply port 640h. In the example shown in FIG. 5, a yellow toner is supplied to the first stirring chamber 640a.

The second stirring screw 644 is disposed in the second stirring chamber 640b. A carrier that is a magnetic material is housed in the second stirring chamber 640b.

The yellow toner is stirred with the carrier by the first stirring screw 643 and the second stirring screw 644. As a result, a two-component developer that includes a carrier and a yellow toner is formed.

The first stirring screw 643 and the second stirring screw 644 stir the two-component developer while circulating it between the first stirring chamber 640a and the second stirring chamber 640b. As a result, the toner is charged to predetermined polarity by friction with the carrier. In the second embodiment, the toner is charged to positive polarity.

The magnetic roller 642 includes a non-magnetic rotating sleeve 642a and a magnet body 642b. The magnet body 642b is fixed to and disposed in the rotating sleeve 642a. The magnet body 642b includes a plurality of magnetic poles. The two-component developer is attracted to the magnetic roller 642 by the magnetic force of the magnet body 642b. As a result, a magnetic brush is formed on the surface of the magnetic roller 642.

In the second embodiment, the magnetic roller 642 rotates in the direction indicated by an arrow R3 in FIG. 5 (counterclockwise direction). The magnetic roller 642 rotates to convey the magnetic brush to the position facing the blade 645. The blade 645 is disposed such that a gap is formed between the blade 645 and the magnetic roller 642. Therefore, the thickness of the magnetic brush is defined by the blade 645. The blade 645 is disposed on the upstream side in the rotation direction of the magnetic roller 642 than the position where the magnetic roller 642 and the development roller 641 face each other.

A predetermined voltage is applied to the development roller 641 and the magnetic roller 642. When the predetermined voltage is applied to obtain a predetermined potential difference between the development roller 641 and the magnetic roller 642, the yellow toner included in the two-component developer migrates to the development roller 641. As a result, the toner thin layer including the yellow toner is formed on the surface of the development roller 641.

The development roller 641 rotates in the direction indicated by an arrow R2 in FIG. 5 (counterclockwise direction). This causes the toner thin layer formed on the surface of the development roller 641 to be conveyed to the position facing the image carrier 65 and adhere to the image carrier 65. In this way, the development device 64 supplies the toner charged due to the friction with the carrier to the surface of the image carrier 65.

The development device 64 of the first image formation unit 62Y has been described above with reference to FIG. 5. Regarding the configuration of the development device 64 of each of the first image formation unit 62Y to the fourth image formation unit 62K, only the type of toner to be supplied from the toner supply unit 50 differs and the other configurations are the same. For this reason, description of the configuration of the development device 64 of each of the second image formation unit 62C to the fourth image formation unit 62K is omitted.

Although an example of the image forming apparatus has been described with reference to FIG. 4 and FIG. 5, the image forming apparatus is not limited to the above image forming apparatus 100. The above image forming apparatus 100 has been described as a color image forming apparatus, but the image forming apparatus may be a monochrome image forming apparatus. In this case, the image forming apparatus only needs to include, for example, one image formation unit. Further, the above image forming apparatus 100 has adopted a tandem method, but the image forming apparatus may adopt, for example, a rotary method. Although a charging roller has been described as an example of the charging device 63, the charging device may be a charging device other than the charging roller (e.g., a scorotron charger, a charging brush, or a corotron charger). The above image forming apparatus 100 has adopted a two-component development method using a two-component developer, but the image forming apparatus may adopt a one-component development method using a one-component developer. The above image forming apparatus 100 has adopted a touch-down development method, but the image forming apparatus may adopt a development method other than the touch-down development method (e.g., a development method in which no development roller is provided and a magnetic roller serves also as a development roller). The above image forming apparatus 100 has adopted an intermediate transfer method, but the image forming apparatus may adopt a direct transfer method. In the case where the image forming apparatus adopts a direct transfer method, a toner image is directly transferred to the recording medium P from the image carrier 65 while the image carrier 65 is in contact with the recording medium P. Although a cleaning blade has been described as an example of the cleaning member 661, the cleaning member may be a cleaning roller. Further, the image forming apparatus does not necessarily need to include the cleaning device 66. Further, the above first image formation unit 62Y to fourth image formation unit 62K have included the static elimination device 67, but the image formation unit does not necessarily need to include a static elimination device.

In particular, in the image forming apparatus 100 according to the second embodiment of the present disclosure, it is favorable to adopt the transfer device 70 that directly transfers a toner image from an image carrier (photoreceptor) to a to-be-transferred body, from the viewpoints of effectively suppressing image defects caused by an image memory and fogging. Here, in the direct transfer method, image defects are likely to occur because the photoreceptor surface tends to be damaged, which decreases the surface potential, in a region where the image carrier 65 and the transfer device 70 directly come into contact with each other without the recording medium P (non-paper-passing portion). Therefore, it is particularly useful in an image forming apparatus in which a toner image is directly transferred from an image carrier (photoreceptor) to a to-be-transferred body.

### Third Embodiment: Process Cartridge

Next, process cartridges 101 to 104 according to a third embodiment of the present disclosure will be described with continued reference to FIG. 4. The process cartridges 101 to 104 according to the third embodiment respectively correspond to the first image formation unit 62Y to the fourth image formation unit 62K. The process cartridges 101 to 104 each include the image carrier 65. The image carrier 65 is the photoreceptor 1 according to the first embodiment. As described in the first embodiment, the photoreceptor 1 according to the first embodiment includes the photosensitive layer 3 that is favorably formed, thereby having excellent wear resistance and being capable of suppressing the occurrence of fogging and an image memory in the formed image. Therefore, the process cartridges 101 to 104 according to the third embodiment include the photoreceptor 1 that is the image carrier 65, which includes the photosensitive layer 3 that is favorably formed, have excellent wear resistance, and are capable of suppressing the occurrence of fogging and an image memory in the formed image.

The process cartridges 101 to 104 further include at least one (e.g., 1 or more and 6 or less) selected from the group consisting of the charging device 63, the exposure device 61, the development device 64, the transfer device 70 (particularly, the primary transfer roller 71), the cleaning device 66, and the static elimination device 67, in addition to the image carrier 65. The process cartridges 101 to 104 are designed to be attachable/detachable to/from the image forming apparatus 100. For this reason, the process cartridges 101 to 104 are easy to handle, and can be easily and quickly replaced together with the image carrier 65 in the case where the sensitivity characteristics or the like of the image carrier 65 deteriorate. The process cartridges 101 to 104 according to the third embodiment have been described above with reference to FIG. 4.

### Example

The present disclosure will be more specifically described below byway of Examples. However, the present disclosure is not limited to the scope of Examples.

### <1. Materials of Photoreceptor>

The following hole transporting agent, charge generating agent, and binder resin were prepared as materials for forming a photosensitive layer of a photoreceptor.

### [1-1. Hole Transporting Agent]

The hole transporting agents (H-1) and (H-2) to be used in Examples, which were described in the first embodiment, and a compound to be used in Comparative Examples, which was represented by the following chemical formula (H-3), were prepared.

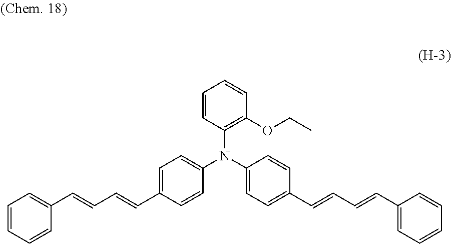 [SMILES: CCOc1ccccc1N(c1ccc(/C=C/C=C/c2ccccc2)cc1)c1ccc(/C=C/C=C/c2ccccc2)cc1]

### [1-2. Phthalocyanine Pigment and Other Pigments]

In Examples, the phthalocyanine pigments (K-1) and (K-2) described in the first embodiment were prepared. In Comparative Examples, compounds represented by the following chemical formulae (K-3), (K-4), and (K-5) were prepared instead of the phthalocyanine pigment.

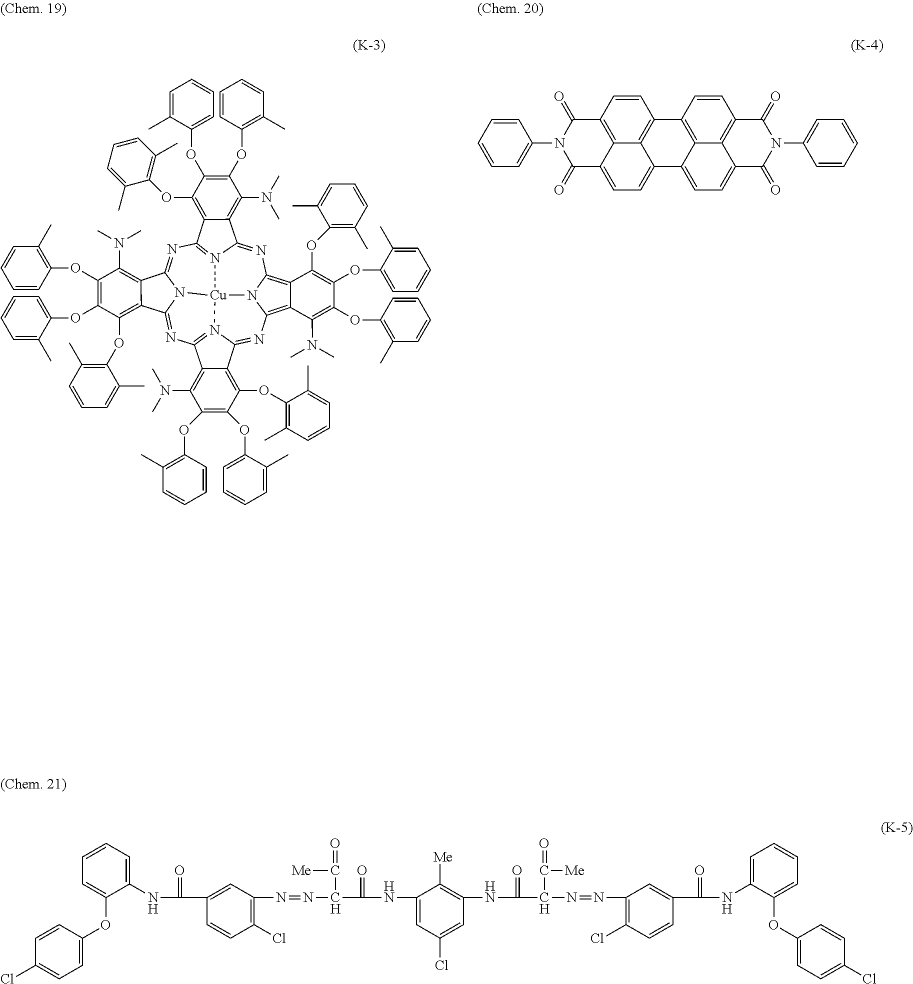

[1-3. Polyarylate resin (R-1) to (R-10)]

Polyarylate resins (R-1) to (R-7) according to Examples and polyarylate resins (R-8) to (R-10) according to Comparative Examples were synthesized by the following method. Hereinafter, the “polyarylate resins (R-1) to (R-10)” will respectively be referred to as resins (R-1) to (R-10) in some cases. The composition of the resins (R-1) to (R-10) is shown in the following Table 3.

TABLE 3

| Monomer | Repeating units derived from bisphenol (%) | | | | | | Repeating units derived from dicarboxylic acid (%) | | | | |
|---|---|---|---|---|---|---|---|---|---|---|---|
| Resin | BP-1-1 | BP-1-2 | BP-1-3 | BP-1-4 | BP-1-5 | BP-2 | DC-3 | DC-4 | DC-5 | DC-6 | n1/n2 |
| R-1 | 37.5 | — | — | — | — | 12.5 | 50 | — | — | — | 3.0 |
| R-2 | 25 | — | — | — | — | 25 | 50 | — | — | — | 1.0 |
| R-3 | — | 37.5 | — | — | — | 12.5 | 50 | — | — | — | 3.0 |
| R-4 | — | — | 37.5 | — | — | 12.5 | 50 | — | — | — | 3.0 |
| R-5 | — | — | — | 37.5 | — | 12.5 | 50 | — | — | — | 3.0 |
| R-6 | — | — | — | — | 37.5 | 12.5 | 50 | — | — | — | 3.0 |
| R-7 | 40 | — | — | — | — | 10 | 32.5 | 17.5 | — | — | 4.0 |
| R-8 | 50 | — | — | — | — | — | | — | 25 | 25 | — |
| R-9 | 50 | — | — | — | — | — | 50 | — | — | — | — |
| R-10 | 20 | — | | — | — | 30 | 50 | — | — | — | 0.7 |

In Table 3, “BP-1-1”, “BP-1-2”, “BP-1-3”, “BP-1-4”, “BP-1-5”, “BP-2”, and “DC-3” respectively indicate the compounds (BP-1-1), (BP-1-2), (BP-1-3), (BP-1-5), (BP-2), and (DC-3) described in the first embodiment. “DC-4”, “DC-5”, and “DC-6” respectively indicate compounds represented by the following chemical formulae (DC-4), (DC-5), and (DC-6) (hereinafter, respectively referred to as compounds (DC-4), (DC-5), and (DC-6) in some cases).

Table 3 shows the percentage (%) of the number of repeating units with respect to the total number of repeating units included in each of the polyarylate resins (R-1) to (R-10).

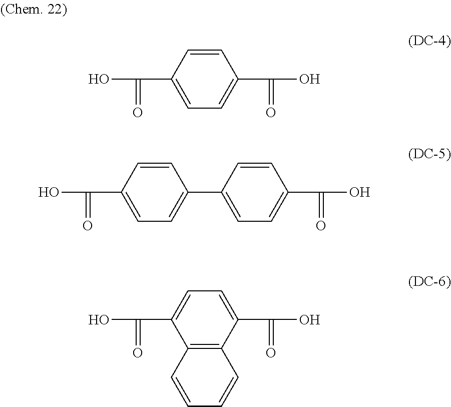

### (Synthesis of Polyarylate Resin (R-1))

A three-neck flask including a thermometer, a three-way cock, and a dropping funnel was used as a reaction vessel. The compound (BP-1-1) (30.9 mmol), the compound (BP-2) (10.3 mmol), p-tert-butylphenol (0.413 mmol), sodium hydroxide (98 mmol), and benzyltributylammonium chloride (0.384 mmol) were added to a reaction vessel. The air in the reaction vessel was replaced with argon gas. Water (300 mL) was added to the content of the reaction vessel. The content of the reaction vessel was stirred at 50° C. for one hour. The content of the reaction vessel was cooled until the temperature of the content of the reaction vessel reached 10° C., thereby obtaining an alkaline aqueous solution A.

Next, dicarboxylic acid dichloride (32.4 mmol) of the compound (DC-3) was dissolved in chloroform (150 mL). In this way, a chloroform solution B was obtained.

The chloroform solution B was slowly added dropwise to the alkaline aqueous solution A using a dropping funnel over 110 minutes. The content of the reaction vessel was stirred for 4 hours while adjusting the temperature of the content of the reaction vessel (liquid temperature) to 15+5° C. to proceed the polymerization reaction. The upper layer (aqueous layer) of the content of the reaction vessel was removed using a decant to obtain an organic layer. Subsequently, ion exchanged water (400 mL) was added to an Erlenmeyer flask. The obtained organic layer was further added to the Erlenmeyer flask. Chloroform (400 mL) and acetic acid (2 mL) were further added to the Erlenmeyer flask. The content of the Erlenmeyer flask was stirred at room temperature (25° C.) for 30 minutes. The upper layer (aqueous layer) of the content of the Erlenmeyer flask was removed using a decant to obtain an organic layer. The obtained organic layer was washed with ion exchanged water (1 L) using a separating funnel. The washing with ion exchanged water was repeated five times to obtain the washed organic layer. Next, the washed organic layer was filtered to obtain a filtrate. The obtained filtrate was slowly added dropwise to methanol (1 L) to obtain a precipitate. The precipitate was collected by filtration. The collected precipitate was vacuum dried at a temperature of 70° C. for 12 hours. In this way, a polyarylate resin (R-1) was obtained.

### (Synthesis of Polyarylate Resin (R-2))

A polyarylate resin (R-2) was obtained by the same method as that for the synthesis of the polyarylate resin (R-1) except that the compound (BP-1-1) (30.9 mmol) and the compound (BP-2) (10.3 mmol) were changed to the compound (BP-1-1) (20.6 mmol) and the compound (BP-2) (20.6 mmol).

### (Synthesis of Polyarylate Resin (R-3))

A polyarylate resin (R-3) was obtained by the same method as that for the synthesis of the polyarylate resin (R-1) except that the compound (BP-1-1) (30.9 mmol) was changed to the compound (BP-1-2) (30.9 mmol).

### (Synthesis of Polyarylate Resin (R-4))

A polyarylate resin (R-4) was obtained by the same method as that for the synthesis of the polyarylate resin (R-1) except that the compound (BP-1-1) (30.9 mmol) was changed to the compound (BP-1-3) (30.9 mmol).

### (Synthesis of Polyarylate Resin (R-5))

A polyarylate resin (R-5) was obtained by the same method as that for the synthesis of the polyarylate resin (R-1) except that the compound (BP-1-1) (30.9 mmol) was changed to the compound (BP-1-4) (30.9 mmol).

### (Synthesis of Polyarylate Resin (R-6))

A polyarylate resin (R-6) was obtained by the same method as that for the synthesis of the polyarylate resin (R-1) except that the compound (BP-1-1) (30.9 mmol) was changed to the compound (BP-1-5) (30.9 mmol).

### (Synthesis of Polyarylate Resin (R-7))

A polyarylate resin (R-7) was obtained by the same method as that for the synthesis of the polyarylate resin (R-1) except that the compound (BP-1-1) (30.9 mmol), the compound (BP-2) (10.3 mmol), and the compound (DC-3) (32.4 mmol) were changed to the compound (BP-1-5) (33.0 mmol), the compound (BP-2) (8.2 mmol), the compound (DC-3) (21.1 mmol), and the compound (DC-4) (11.3 mmol).

### (Synthesis of Polyarylate Resin (R-8))

A polyarylate resin (R-8) was obtained by the same method as that for the synthesis of the polyarylate resin (R-1) except that the compound (BP-1-1) (30.9 mmol), the compound (BP-2) (10.3 mmol), and the compound (DC-3) (32.4 mmol) were changed to the compound (BP-1-5) (41.2 mmol), the compound (DC-5) (16.2 mmol), and the compound (DC-6) (12.6 mmol).

### (Synthesis of Polyarylate Resin (R-9))

A polyarylate resin (R-9) was obtained by the same method as that for the synthesis of the polyarylate resin (R-1) except that the compound (BP-1-1) (30.9 mmol) and the compound (BP-2) (10.3 mmol) were changed to the compound (BP-1-1) (41.2 mmol).

### (Synthesis of Polyarylate Resin (R-10))

A polyarylate resin (R-10) was obtained by the same method as that for the synthesis of the polyarylate resin (R-1) except that the compound (BP-1-1) (30.9 mmol) and the compound (BP-2) (10.3 mmol) were changed to the compound (BP-1-1) (16.5 mmol) and the compound (BP-2) (24.7 mmol).

The viscosity average molecular weights of the obtained polyarylate resins (R-1), (R-2), (R-3), (R-4), (R-5), and (R-6) were respectively 50500, 48,700, 45,000, 47,300, 45,500, and 51,000.

The 1H-NMR spectrum of each of the obtained polyarylate resins (R-1) to (R-7) was measured using a proton nuclear magnetic resonance spectrometer (manufactured by JASCO Corporation, 300 MHz). CDCl3 was used as the solvent. Tetramethylsilane (TMS) was used as the internal standard sample. Chemical shift values of the polyarylate resin (R-2) as a representative example of the polyarylate resins (R-1) to (R-6) are shown below. The fact that the polyarylate resin (R-2) was obtained was confirmed on the basis of the chemical shift values. For the polyarylate resins (R-1) to (R-6), the fact that the polyarylate resins (R-1) to (R-6) were obtained was confirmed in the same manner.

Polyarylate resin (R-2): 1H-NMR (300 MHz, CDCl3) δ=8.21-8.26 (m, 8H), 7.25-7.29 (m, 4H), 7.07-7.23 (m, 20H), 2.16 (q, 2H), 1.65 (s, 3H), 0.78 (t, 3H).

### <2. Production of Photoreceptor>

Each of photoreceptors according to Examples 1 to 14 and Comparative Examples 1 to 8 were prepared using the above materials for forming a photosensitive layer.

### Example 1

### (Preparation of Stacked Photoreceptor for Evaluation)

2 parts by mass of titanium oxide that has been subjected to surface treatment with alumina and silica and then surface treatment with methylhydrogenpolysiloxane while wet dispersing (SMT-A manufactured by TAYCA Co., Ltd., a number average primary particle size of 10 nm), 1 part by mass of a quaternary copolymerized polyamide resin (Amilan CM8000 manufactured by TORAY INDUSTRIES, INC.), 10 parts by mass of methanol, 1 part by mass of butanol, and 1 part by mass of toluene were dispersed for 5 hours using a bead mill, thereby preparing a coating liquid for an undercoat layer.

The obtained coating liquid for an undercoat layer was filtered using a 5 μm filter and then applied to an aluminum drum-shaped support having a diameter of 30 mm as a conductive support by a dip coating method, and heat treatment was performed at 130° C. for 30 minutes to form an undercoat layer having a film thickness of 1.5 μm.

Next, 2.3 parts by mass of Y-type titanyl phthalocyanine, 1 part by mass of a polyvinylacetal resin (S-LEC BX-5 manufactured by SEKISUI CHEMICAL CO., LTD.) as a binder resin, 40 parts by mass of propylene glycol monomethyl ether as a dispersion medium, and 40 parts by mass of tetrahydrofuran were mixed and dispersed for 12 hours using a bead mill, thereby preparing a coating liquid for a charge generating layer.

The obtained coating liquid was filtered using a 3 μm filter, then applied onto the undercoat layer prepared above by a dip coating method, and dried at 50° C. for 5 minutes to form a charge generating layer having a film thickness of 0.3 μm.

Next, 45 parts by mass of a compound represented by the formula (H-1) as a hole transporting agent, 100 parts by mass of a polyarylate resin represented by the formula (R-1) as a binder resin, 0.1 parts by mass of Y-type titanyl phthalocyanine (K-1), 0.05 parts by mass of dimethylsilicone oil KF96-50CS as a leveling agent, 560 parts by mass of tetrahydrofuran as a solvent, and 140 parts by mass of toluene were mixed to prepare a coating liquid for a charge transporting layer.

The prepared coating liquid for a charge transporting layer was applied onto the charge generating layer in the same manner as that for the coating liquid for a charge generating layer and dried at 120° C. for 40 minutes to form a charge transporting layer having a film thickness of 20 μm, thereby preparing a stacked electrophotographic photoreceptor (A-1).

### Example 2

A stacked electrophotographic photoreceptor (A-2) was prepared in the same manner as that in Example 1 except that the amount of Y-type titanyl phthalocyanine in the coating liquid for a charge transporting layer was changed from 0.1 parts by mass to 0.3 parts by mass.

### Example 3

A stacked electrophotographic photoreceptor (A-3) was prepared in the same manner as that in Example 1 except that the amount of Y-type titanyl phthalocyanine in the coating liquid for a charge transporting layer was changed from 0.1 parts by mass to 0.5 parts by mass.

### Example 4

A stacked electrophotographic photoreceptor (A-4) was prepared in the same manner as that in Example 1 except that the amount of Y-type titanyl phthalocyanine in the coating liquid for a charge transporting layer was changed from 0.1 parts by mass to 0.6 parts by mass.

### Example 5

A stacked electrophotographic photoreceptor (A-5) was prepared in the same manner as that in Example 2 except that the titanyl phthalocyanine in the coating liquid for a charge transporting layer was changed from K-1 to K-2.

### Example 6

A stacked electrophotographic photoreceptor (A-6) was prepared in the same manner as that in Example 2 except that the binder resin in the coating liquid for a charge transporting layer was changed from R-1 to R-2.

### Example 7

A stacked electrophotographic photoreceptor (A-7) was prepared in the same manner as that in Example 2 except that the binder resin in the coating liquid for a charge transporting layer was changed from R-1 to R-3.

### Example 8

A stacked electrophotographic photoreceptor (A-8) was prepared in the same manner as that in Example 2 except that the binder resin in the coating liquid for a charge transporting layer was changed from R-1 to R-4.

### Example 9

A stacked electrophotographic photoreceptor (A-9) was prepared in the same manner as that in Example 2 except that the binder resin in the coating liquid for a charge transporting layer was changed from R-1 to R-5.

### Example 10

A stacked electrophotographic photoreceptor (A-10) was prepared in the same manner as that in Example 2 except that the binder resin in the coating liquid for a charge transporting layer was changed from R-1 to R-6.

### Example 11

A stacked electrophotographic photoreceptor (A-11) was prepared in the same manner as that in Example 2 except that the binder resin in the coating liquid for a charge transporting layer was changed from R-1 to R-7.

### Example 12

A stacked electrophotographic photoreceptor (A-12) was prepared in the same manner as that in Example 2 except that the hole transporting agent in the coating liquid for a charge transporting layer was changed from (H-1) to (H-2).

### Example 13

A stacked electrophotographic photoreceptor (A-13) was prepared in the same manner as that in Example 2 except that the amount of the hole transporting agent (H-1) in the coating liquid for a charge transporting layer was changed from 45 parts by mass to 30 parts by mass.

### Example 14

A stacked electrophotographic photoreceptor (A-14) was prepared in the same manner as that in Example 2 except that the amount of the hole transporting agent (H-1) in the coating liquid for a charge transporting layer was changed from 45 parts by mass to 60 parts by mass.

### Comparative Example 1

A stacked electrophotographic photoreceptor (B-1)was prepared in the same manner as that in Example 1 except that the amount of Y-type titanyl phthalocyanine in the coating liquid for a charge transporting layer was changed from 0.1 parts by mass to 0 part by mass.

### Comparative Example 2

A stacked electrophotographic photoreceptor (B-2) was prepared in the same manner as that in Comparative Example 1 except that the hole transporting agent in the coating liquid for a charge transporting layer was changed from (H-1) to (H-3).

### Comparative Example 3

A stacked electrophotographic photoreceptor (B-3) was prepared in the same manner as that in Example 2 except that the binder resin in the coating liquid for a charge transporting layer was changed from (R-1) to (R-8).

### Comparative Example 4

A stacked electrophotographic photoreceptor (B-4) was prepared in the same manner as that in Example 2 except that the binder resin in the coating liquid for a charge transporting layer was changed from (R-1) to (R-9).

### Comparative Example 5

A stacked electrophotographic photoreceptor (B-5) was prepared in the same manner as that in Example 2 except that the binder resin in the coating liquid for a charge transporting layer was changed from (R-1) to (R-10).

### Comparative Example 6

A stacked electrophotographic photoreceptor (B-6) was prepared in the same manner as that in Example 2 except that the titanyl phthalocyanine in the coating liquid for a charge transporting layer was changed from K-1 to K-3.

### Comparative Example 7

A stacked electrophotographic photoreceptor (B-7) was prepared in the same manner as that in Example 1 except that the titanyl phthalocyanine in the coating liquid for a charge transporting layer was changed from (K-1) to (K-4).

### Comparative Example 8

A stacked electrophotographic photoreceptor (B-8) was prepared in the same manner as that in Example 2 except that the titanyl phthalocyanine in the coating liquid for a charge transporting layer was changed from (K-1) to (K-5).

### <3. Evaluation of Photoreceptor>

### [3-1. Evaluation of Electrical Characteristics]

The sensitivity (post-exposure potential) of each of the prepared electrophotographic photoreceptors (A-1) to (A-14) and (B-1) to (B-8) was measured using an electrical characteristic tester manufactured by GENTEC, and sensitivity characteristics when printing a solid image (hereinafter, referred to as sensitivity characteristics A in some cases) and sensitivity characteristics when printing a halftone image (hereinafter, referred to as sensitivity characteristics B in some cases) were evaluated.

In detail, the photoreceptor was charged using the above electrical characteristic tester in an environment of a temperature of 25° C. and a relative humidity of 50% RH such that the surface potential of the photoreceptor would be −500 V. Subsequently, monochromatic light (wavelength: 780 nm) was extracted using a bandpass filter from the light of a halogen lamp and applied to the surface of the photoreceptor. The surface potential of the photoreceptor at the time point when 77 ms elapsed since the end of application of monochromatic light was measured and used as a post-exposure potential (V, unit: −V). Further, monochromatic light with a different exposure amount was applied.

For the measurement of the sensitivity characteristics A, the exposure conditions for forming a solid image were set to the exposure amount of 0.30 μJ/cm² and the post-exposure potential of VA.

For the measurement of the sensitivity characteristics B, the exposure conditions for forming a halftone image were set to the exposure amount of 0.15 μJ/cm² and the post-exposure potential of VB.

The post-exposure potentials VA and VB of each photoreceptor are shown in Table 3. The sensitivity characteristics A and the sensitivity characteristics B of the photoreceptor were evaluated in accordance with the following criteria.

### (Sensitivity Characteristics A)

The post-exposure potential with the exposure amount: 0.30 μJ/cm² of 100 V or less in absolute value was evaluated as very good, that of exceeding 100 V and 110 V or less was evaluated as good (Pass), and that of exceeding 110 V was evaluated as poor (Fail).

### (Sensitivity Characteristics B)

The post-exposure potential with the exposure amount: 0.15 μJ/cm² of 200 V or less in absolute value was evaluated as very good, that of exceeding 200 V and less than 260 V was evaluated as good (Pass), and that of 260 V or more was evaluated as poor (Fail).

### (Evaluation of Sensitivity Characteristics of Photoreceptor)

In the case where both the sensitivity characteristics A and B are evaluated to “Pass”, which allow a solid image and a halftone image to be formed favorably, The sensitivity of the photoreceptor can be evaluated as good.

### [3-2. Wear Test Evaluation]

A color printer (“C844dnw” manufactured by Oki Electric Industry Co., Ltd.) was used as an evaluation device. The toner cartridge of the evaluation device was filled with a cyan toner. First, a film thickness Ti of the charge transporting layer of the stacked photoreceptor was measured. Subsequently, the stacked photoreceptor was mounted on the evaluation device. Subsequently, under a normal temperature and normal humidity environment (a temperature of 23° C. and a relative humidity of 50% RH: hereinafter, referred to as an NN environment in some cases), an image I (pattern image with a coverage rate of 1%) was printed on 4,000 sheets of paper using the evaluation device. Subsequently, under a high-temperature and high-humidity environment (a temperature of 32° C. and a relative humidity of 85% RH: hereinafter, referred to as an HH environment in some cases), the image I was printed on 4,000 sheets of paper using the evaluation device. Subsequently, under a low-temperature and low-humidity environment (a temperature of 10° C. and a relative humidity of 15% RH: hereinafter, referred to as an LL environment in some cases), the image I was printed on 4,000 sheets of paper using the evaluation device. After the printing in the LL environment, the evaluation device was allowed to stand for 2 hours. Subsequently, a solid image (image with image density of 100%) was printed on one sheet of paper in the LL environment, and this was used as an evaluation image. After that, a film thickness T2 of the charge transporting layer of the stacked photoreceptor was measured. The amount of wear (T1−T2, unit: μm) that is a change amount of the film thickness of the charge transporting layer before and after the printing was obtained. The results are shown in Table 3. Note that the smaller the amount of wear, the more excellent the wear resistance of the stacked photoreceptor.

### [3-3. Evaluation of Image Memory]

A color printer (“C844dnw” manufactured by Oki Electric Industry Co., Ltd.) was used as an evaluation device. The toner cartridge of the evaluation device was filled with a cyan toner. The electrophotographic photoreceptor obtained in each of Examples and Comparative Examples was mounted on the cyan cartridge, and they were mounted on the above printer. The media type (recording paper) for printing was set to thick paper, and 100 cyan images were printed on Laser Peach WETY-145 A4 (manufactured by Oji Paper Co., Ltd.) in a vertical feed mode. Next, a cyan halftone image (image density of 50%) was printed on A3 plain paper, and evaluation was performed. The density difference between the Laser-Peach-passing area (portion where the photoreceptor was damaged by transfer through the Laser Peach) and the Laser-Peach-non-passing area (portion where the photoreceptor is damaged directly by transfer) of the halftone image printed on the A3 plain paper was visually checked. Then, whether or not the image memory was suppressed was evaluated in accordance with the following criteria. The evaluation results are shown in Table 3.

### (Evaluation Criteria for Image Memory)

Evaluation A: no image density difference is observed between the Laser-Peach-passing area and non-passing area
Evaluation B: a slight image density difference is observed between the Laser-Peach-passing area and non-passing area
Evaluation C: a clear image density difference is observed between the Laser-Peach-passing area and non-passing area

### [3-4. Evaluation of Fogging]

A color printer (“C844dnw” manufactured by Oki Electric Industry Co., Ltd.) was used as an evaluation device. The toner cartridge of the evaluation device was filled with a cyan toner. Under the HH environment, the image I was printed on 2,000 sheets of paper using the evaluation device. After causing the evaluation device to be left to stand under the HH environment for 12 hours, a blank sheet of paper was printed, and then, the toner adhering to the drum surface was collected using Scotch Mending Tape (manufactured by 3M) and evaluated using a spectrodensitometer. Then, whether or not fogging was suppressed was evaluated in accordance with the following criteria. The evaluation results are shown in Table 3.

### (Evaluation Criteria for Fogging)

Evaluation A (Particularly good): density of 1.40 or less
Evaluation B (Good): density of exceeding 1.40 and less than 1.61
Evaluation C (Poor): density of 1.61 or more

In Table 4, “Resin” indicates a polyarylate resin, “HTM” indicates a hole transporting agent, and “Amount” indicates the content of each component with respect to 100 parts by mass of the polyarylate resin. “Sensitivity characteristics A” indicates the evaluation of the sensitivity characteristics A, “Sensitivity characteristics B” indicates the evaluation of the sensitivity characteristics B, and “V” indicates the post-exposure potential of the photoreceptor in the evaluation of each of the sensitivity characteristics. “-” indicates that the corresponding component is not used. “Not dissolved” indicates that when preparing a coating liquid for a charge transporting layer, the binder resin was not dissolved in the solvent and no charge transporting layer could be formed.

TABLE 4

| | | | | | Phthalocyanine | | | | | | |
|---|---|---|---|---|---|---|---|---|---|---|---|
| | | | | | pigment or | | Sensitivity | Sensitivity | Amount | | |
| | | | HTM | | other pigments | | characteristics A | characteristics B | of wear | Image | |
| | No. | Resin | Type | Amount | Type | Amount | V | V | μm | memory | Fogging |
| Example 1 | A-1 | R-1 | H-1 | 45 | K-1 | 0.1 | 46 | 139 | 1.3 | B | B |
| Example 2 | A-2 | R-1 | H-1 | 45 | K-1 | 0.3 | 48 | 154 | 1.4 | A | A |
| Example 3 | A-3 | R-1 | H-1 | 45 | K-1 | 0.5 | 98 | 226 | 1.4 | A | A |
| Example 4 | A-4 | R-1 | H-1 | 45 | K-1 | 0.6 | 110 | 259 | 1.4 | A | A |
| Example 5 | A-5 | R-1 | H-1 | 45 | K-2 | 0.3 | 60 | 201 | 1.5 | B | A |
| Example 6 | A-6 | R-2 | H-1 | 45 | K-1 | 0.3 | 48 | 155 | 1.3 | A | A |
| Example 7 | A-7 | R-3 | H-1 | 45 | K-1 | 0.3 | 49 | 152 | 1.3 | A | A |
| Example 8 | A-8 | R-4 | H-1 | 45 | K-1 | 0.3 | 50 | 155 | 1.4 | A | A |
| Example 9 | A-9 | R-5 | H-1 | 45 | K-1 | 0.3 | 52 | 159 | 1.1 | A | A |
| Example 10 | A-10 | R-6 | H-1 | 45 | K-1 | 0.3 | 50 | 153 | 1.0 | A | A |
| Example 11 | A-11 | R-7 | H-1 | 45 | K-1 | 0.3 | 57 | 163 | 1.5 | A | A |
| Example 12 | A-12 | R-1 | H-2 | 45 | K-1 | 0.3 | 55 | 158 | 1.4 | A | A |
| Example 13 | A-13 | R-1 | H-1 | 30 | K-1 | 0.3 | 78 | 178 | 1.2 | A | A |
| Example 14 | A-14 | R-1 | H-1 | 60 | K-1 | 0.3 | 35 | 126 | 1.6 | A | A |
| Comparative | B-1 | R-1 | H-1 | 45 | — | — | 46 | 126 | 1.2 | C | C |
| Example 1 | | | | | | | | | | | |
| Comparative | B-2 | R-1 | H-3 | 45 | — | — | 39 | 120 | 1.3 | C | C |
| Example 2 | | | | | | | | | | | |
| Comparative | B-3 | R-8 | H-1 | 45 | K-1 | 0.3 | 53 | 160 | 2.5 | A | A |
| Example 3 | | | | | | | | | | | |
| Comparative | B-4 | R-9 | H-1 | 45 | K-1 | 0.3 | 55 | 159 | 3.0 | A | A |
| Example 4 | | | | | | | | | | | |
| Comparative | B-5 | R-10 | H-1 | 45 | K-1 | 0.3 | Not dissolved | | | | |
| Example 5 | | | | | | | | | | | |
| Comparative | B-6 | R-1 | H-1 | 45 | K-3 | 0.3 | 55 | 145 | 1.2 | C | B |
| Example 6 | | | | | | | | | | | |
| Comparative | B-7 | R-1 | H-1 | 45 | K-4 | 0.3 | 58 | 160 | 1.2 | C | A |
| Example 7 | | | | | | | | | | | |
| Comparative | B-8 | R-1 | H-1 | 45 | K-5 | 0.3 | 66 | 179 | 1.3 | C | B |
| Example 8 | | | | | | | | | | | |

As shown in Table 2, the photosensitive layers (more specifically, the charge transporting layers) of the stacked photoreceptors (A-i) to (A-14) included, as binder resins, the polyarylate resins (R-1) to (R-7) including the repeating unit (1), the repeating unit (2), and the repeating unit (3), in which the ratio n₁/n₂ of the number n₁ of the repeating unit (1) to the number n₂ of the repeating unit (2) is 1.0 or more. For this reason, the amount of wear of each of the stacked photoreceptors (A-1) to (A-14) was 1.6 ~m or less as shown in Table 3, and the stacked photoreceptors (A-1) to (A-14) had excellent wear resistance.

On the other hand, the photosensitive layers of the stacked photoreceptors (B-3) and (B-4) includes, as binder resins, the polyarylate resins (R-8) and (R-9) that included the repeating unit (1) and the repeating unit (3) but did not include the repeating unit (2). For this reason, the amount of wear of each of the stacked photoreceptors (B-3) and (B-4) was 2.5 μm or more as shown in Table 3, and the stacked photoreceptors (A-1) to (A-14) did not have excellent wear resistance.

Further, the photosensitive layer of the stacked photoreceptor (B-5) included, as a binder resin, the polyarylate resin (R-10) including the repeating unit (1), the repeating unit (2), and the repeating unit (3), in which the ratio n₁/n₂ of the number n₁ of the repeating unit (1) to the number n₂ of the repeating unit (2) is less than 1.0. For this reason, in the stacked photoreceptor (B-5) using such a binder resin, the polyarylate resin was not dissolved, no film was formed, and thus, no evaluation including evaluation of the amount of wear could be performed.

As shown in Table 2, the photosensitive layers (more specifically, the charge transporting layers) of the stacked photoreceptors (A-1) to (A-14) included the hole transporting agents (H-1) and (H-2) encompassed in the hole transporting agent (10), and included the phthalocyanine pigments (K-1) and (K-2) encompassed in the phthalocyanine pigment according to the present disclosure as phthalocyanine pigments. For this reason, in the stacked photoreceptors (A-1) to (A-14), the evaluation of an image memory and the evaluation of fogging were A or B, and image defects caused by the image memory and fogging were suppressed. Further, the post-exposure potential VA was 110 V or less, the post-exposure potential VB was 260 V or less, and thus, the sensitivity characteristics A and the sensitivity characteristics B were evaluated as good. In particular, since the content of the predetermined phthalocyanine pigment was 0.15 parts by mass or more with respect to 100.00 parts by mass of the binder resin and the phthalocyanine pigment (K-1) was used in the photosensitive layers of the stacked photoreceptors (A-2) to (A-4) and (A-6) to (A-14), the evaluation of an image memory and the evaluation of fogging were both A. Further, the content of the predetermined phthalocyanine pigment was 0.5 parts by mass or less with respect to 100.00 parts by mass of the binder resin in the photosensitive layer of the stacked photoreceptors (A-2), (A-3), and (A-5) to (A-14), the sensitivity characteristics A and the sensitivity characteristics B were evaluated as very good.

On the other hand, the photosensitive layers of the stacked photoreceptors (B-1) and (B-2) did not include the phthalocyanine pigment according to the present disclosure. Further, the photosensitive layer of the stacked photoreceptor (B-2) included the hole transporting agent (H-3) that was not encompassed in the hole transporting agent (10), and did not include the hole transporting agent (10). For this reason, in the stacked photoreceptors (B-1) and (B-2), the evaluation of an image memory and the evaluation of fogging were both C and image defects could not be sufficiently suppressed, although the post-exposure potential VA was 110 V or less, the post-exposure potential VB was 260 V or less, and thus, the sensitivity characteristics A, and the sensitivity characteristics B were evaluated as good.

On the other hand, the photosensitive layers of the stacked photoreceptors (B-6) to (B-8) did not include the phthalocyanine pigment according to the present disclosure. For this reason, in the stacked photoreceptors (B-6) to (B-8), the evaluation of an image memory was C and image defects could not be sufficiently suppressed, although the post-exposure potential VA was 110 V or less, the post-exposure potential VB was 260 V or less, and thus, the sensitivity characteristics A and the sensitivity characteristics B were evaluated as good.

From the above, it has been shown that the photoreceptor according to the present disclosure is capable of improving wear resistance and suppressing image defects such as an image memory and fogging in the formed image.

It should be understood by those skilled in the art that various modifications, combinations, sub-combinations and alterations may occur depending on design requirements and other factors insofar as they are within the scope of the appended claims or the equivalents thereof.

What is claimed is:

1. An electrophotographic photoreceptor, comprising:
a conductive base; and
a photosensitive layer,
the photosensitive layer including a charge generating layer and a charge transporting layer,
the charge transporting layer including a hole transporting agent, a binder resin, and a phthalocyanine pigment,
the binder resin including a polyarylate resin,
the polyarylate resin including a repeating unit represented by the following general formula (1), a repeating unit represented by the following chemical formula (2), and a repeating unit represented by the following chemical formula (3),
a ratio n₁/n₂ of the number n₁ of repeating units represented by the general formula (1) to the number n₂ of repeating unit represented by the chemical formula (2) being 1.0 or more,
the hole transporting agent including a compound represented by the following general formula (10): 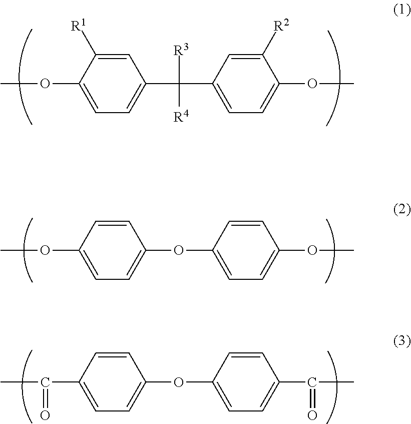
in the general formula (1),
R¹ and R² each independently represent a hydrogen atom or a methyl group, R³ represents a methyl group, and R⁴ represents a hydrogen atom or an alkyl group having 2 or 3 carbon atoms, or
R¹ and R² each independently represent a methyl group, and R³ and R⁴ are bonded to each other to represent a cycloalkylidene group having 5 or 6 carbon atoms; 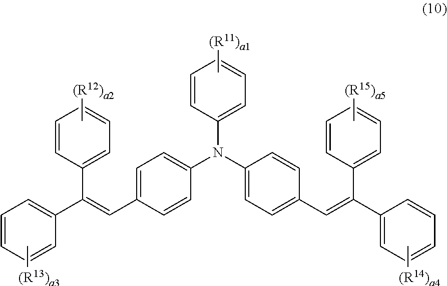
in the general formula (10),
R¹¹ to R¹⁵ each independently represent an alkyl group having 1 to 8 carbon atoms or an alkoxy group having 1 to 8 carbon atoms, and a1, a2, a3, a4, and a5 each independently represent an integer of 0 or more and 5 or less.

2. The electrophotographic photoreceptor according to claim 1, wherein the repeating unit represented by the general formula (1) is a repeating unit represented by the following chemical formula (1-1), chemical formula (1-2), chemical formula (1-3), chemical formula (1-4), or chemical formula (1-5):

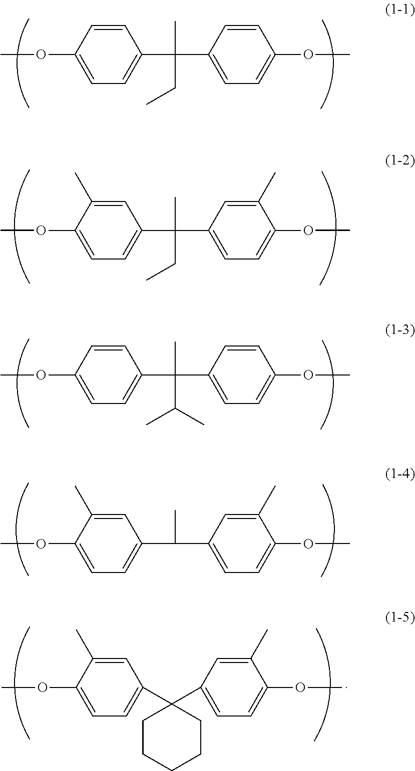

3. The electrophotographic photoreceptor according to claim 1, wherein
the phthalocyanine pigment is metal-free phthalocyanine or a compound represented by the following general formula (11): 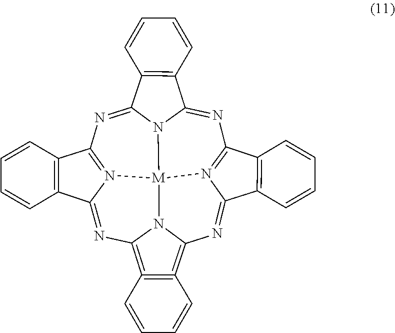
in the general formula (11), M represents a metal atom that may have a ligand.

4. The electrophotographic photoreceptor according to claim 1, wherein
a content of the phthalocyanine pigment is 0.10 parts by mass or more and 0.60 parts by mass or less with respect to 100 parts by mass of the binder resin.

5. The electrophotographic photoreceptor according to claim 1, wherein
the phthalocyanine pigment is titanyl phthalocyanine.

6. A process cartridge, comprising:
the electrophotographic photoreceptor according to claim 1.

7. An image forming apparatus, comprising:
an image carrier;
a charging device that charges a surface of the image carrier;
an exposure device that exposes the charged surface of the image carrier to form an electrostatic latent image on the surface of the image carrier;
a development device that supplies a toner to the surface of the image carrier to develop the electrostatic latent image as a toner image; and
a transfer device that transfers the toner image from the image carrier to a to-be-transferred body,
the image carrier being the electrophotographic photoreceptor according to claim 1.

8. The image forming apparatus according to claim 7, wherein
the toner image is directly transferred from the image carrier to the to-be-transferred body.
